(19) United States
(12) Patent Application Publication
(10) Pub. No.: US 2022/0309234 A1
(43) Pub. Date: Sep. 29, 2022

(54) INFORMATION PROCESSING APPARATUS, INFORMATION PROCESSING SYSTEM, AND INFORMATION PROCESSING METHOD

(71) Applicant: Ryo IWASAKI, Tokyo (JP)

(72) Inventor: Ryo IWASAKI, Tokyo (JP)

(21) Appl. No.: 17/672,690

(22) Filed: Feb. 16, 2022

(30) Foreign Application Priority Data
Mar. 23, 2021 (JP) 2021-048321

(51) Int. Cl. G06F 40/174; G06Q 30/04

(52) U.S. Cl. CPC G06F 40/174; G06Q 30/04

(57) ABSTRACT

An information processing apparatus includes circuitry that registers a plurality of first form information items based on an operation of a first terminal apparatus. The circuitry further generates a second form information item corresponding to the plurality of first form information items based on an operation of a second terminal apparatus, and registers the generated second form information item in association with the plurality of first form information items. The circuitry further causes the first terminal apparatus to display association information in which the plurality of first form information items and the second form information item are associated with each other.

### CROSS-REFERENCE TO RELATED APPLICATION

This patent application is based on and claims priority pursuant to 35 U.S.C. § 119(a) to Japanese Patent Application No. 2021-048321, filed on Mar. 23, 2021, in the Japan Patent Office, the entire disclosure of which is hereby incorporated by reference herein.

### BACKGROUND

### Technical Field

The present invention relates to an information processing apparatus, an information processing system, and an information processing method.

### Description of the Related Art

There is a technique of comparing purchase description data by supplier with corresponding invoice description data by buyer to execute automatic matching of trading goods.

In a sales transaction, a supplier may send a buyer a batch invoice for a plurality of orders placed by the buyer. In this case, a single invoice is issued for a plurality of order sheets. It is therefore difficult to identify a first form and a second form related to the sales transaction in work such as reconciliation work of checking whether the sum of the prices in the plurality of order sheets issued by the buyer matches the price in the single invoice received by the buyer, for example. This issue arises not only in the work with the order sheet and the invoice but also in work with other forms such as a quotation and a statement of delivery.

### SUMMARY

In one embodiment of this invention, there is provided an information processing apparatus that includes, for example, circuitry that registers a plurality of first form information items based on an operation of a first terminal apparatus. The circuitry further generates a second form information item corresponding to the plurality of first form information items based on an operation of a second terminal apparatus, and registers the generated second form information item in association with the plurality of first form information items. The circuitry further causes the first terminal apparatus to display association information in which the plurality of first form information items and the second form information item are associated with each other.

In one embodiment of this invention, there is provided an information processing system that includes, for example, an information processing apparatus and a first terminal apparatus. The information processing apparatus includes circuitry that registers a plurality of first form information items based on an operation of the first terminal apparatus. The circuitry further generates a second form information item corresponding to the plurality of first form information items based on an operation of a second terminal apparatus, and registers the generated second form information item in association with the plurality of first form information items. The circuitry further transmits, to the first terminal apparatus, association information in which the plurality of first form information items and the second form information item are associated with each other. The first terminal apparatus includes a display that displays the association information.

In one embodiment of this invention, there is provided an information processing method that includes, for example, registering a plurality of first form information items based on an operation of a first terminal apparatus, generating a second form information item corresponding to the plurality of first form information items based on an operation of a second terminal apparatus and registering the generated second form information item in association with the plurality of first form information items, and causing the first terminal apparatus to display association information in which the plurality of first form information items and the second form information item are associated with each other.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example of the system configuration of a transaction management system according to a first embodiment of the present invention;

FIG. 2 is a diagram illustrating an example of the hardware configuration of a transaction management apparatus included in the transaction management system of the first embodiment;

FIG. 3 is a diagram illustrating an example of the hardware configuration of a terminal apparatus included in the transaction management system of the first embodiment;

FIG. 4 is a diagram illustrating an example of an issued order sheet database of the first embodiment;

FIG. 5 is a diagram illustrating an example of a received order sheet database of the first embodiment;

FIG. 6 is a diagram illustrating an example of an issued invoice database of the first embodiment;

FIG. 7 is a diagram illustrating an example of a received invoice database of the first embodiment;

FIG. 8 is a diagram illustrating an example of a tenant database of the first embodiment;

FIG. 9 is a diagram illustrating an example of a receipt management database of the first embodiment;

FIG. 10 is a diagram illustrating an example of an output database of the first embodiment;

FIG. 11 is a diagram illustrating functions of a transaction management unit included in the transaction management apparatus of the first embodiment;

FIG. 12 a diagram illustrating functions of terminal apparatuses included in the transaction management system of the first embodiment;

FIG. 13 is a sequence diagram illustrating an operation of the transaction management system of the first embodiment;

FIG. 14 is a diagram illustrating an example of an order sheet creation screen of the first embodiment;

FIG. 15 is a diagram illustrating an example of an order sheet transmission screen of the first embodiment;

FIG. 16 is a diagram illustrating an example of an electronic mail screen of the first embodiment;

FIG. 17 is a diagram illustrating an example of an order sheet information receipt screen of the first embodiment;

FIG. 18 is a diagram illustrating another example of the order sheet information receipt screen of the first embodiment;

FIG. 19 is a sequence diagram illustrating another operation of the transaction management system of the first embodiment;

FIG. 20 is a diagram illustrating an example of an order sheet list screen of the first embodiment;

FIG. 21 is a diagram illustrating an example of an invoice creation screen of the first embodiment;

FIG. 22 is a diagram illustrating an example of an edit screen of the first embodiment;

FIG. 23 is a diagram illustrating an example of a combined invoice transmission screen of the first embodiment;

FIG. 24 is a flowchart illustrating a process of a reconciliation unit included in the transaction management unit of the first embodiment;

FIG. 25 is a sequence diagram illustrating another operation of the transaction management system of the first embodiment;

FIG. 26 is a diagram illustrating an example of an invoice list screen of the first embodiment;

FIG. 27 is a diagram illustrating an example of a check screen of the first embodiment;

FIG. 28 is a diagram illustrating another example of the invoice list screen of the first embodiment;

FIG. 29 is a diagram illustrating another example of the check screen of the first embodiment;

FIG. 30 is a sequence diagram illustrating an operation of the transaction management system according to a second embodiment of the present invention:

FIG. 31 is a diagram illustrating an example of the order sheet list screen of the second embodiment;

FIG. 32 is a diagram illustrating an example of the invoice creation screen of the second embodiment;

FIG. 33 is a diagram illustrating a process of a registration unit included in the transaction management unit of the second embodiment;

FIG. 34 is a diagram illustrating another example of the invoice creation screen of the second embodiment;

FIG. 35 is a diagram illustrating another process of the registration unit of the second embodiment;

FIG. 36 is a diagram illustrating another example of the order sheet list screen of the second embodiment;

FIG. 37 is a diagram illustrating another example of the invoice creation screen of the second embodiment;

FIGS. 38 and 39 are diagrams illustrating other processes of the registration unit of the second embodiment;

FIG. 40 is a diagram illustrating an example of the invoice list screen of the second embodiment;

FIG. 41 is a sequence diagram illustrating another operation of the transaction management system of the second embodiment;

FIG. 42 is a diagram illustrating another example of the order sheet list screen of the second embodiment;

FIG. 43 is a diagram illustrating an example of the check screen of the second embodiment;

FIG. 44 is a diagram illustrating an example of the order sheet list screen according to a third embodiment of the present invention;

FIG. 45 is a diagram illustrating an example of the invoice creation screen of the third embodiment;

FIG. 46 is a diagram illustrating an example of the received invoice database of the third embodiment; and

FIG. 47 is a diagram illustrating an example of the invoice list screen of the third embodiment.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. In the drawings illustrating embodiments of the present invention, members or components having the same function or shape will be denoted with the same reference numerals to avoid redundant description.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Embodiments of the present invention will be described below with reference to the drawings.

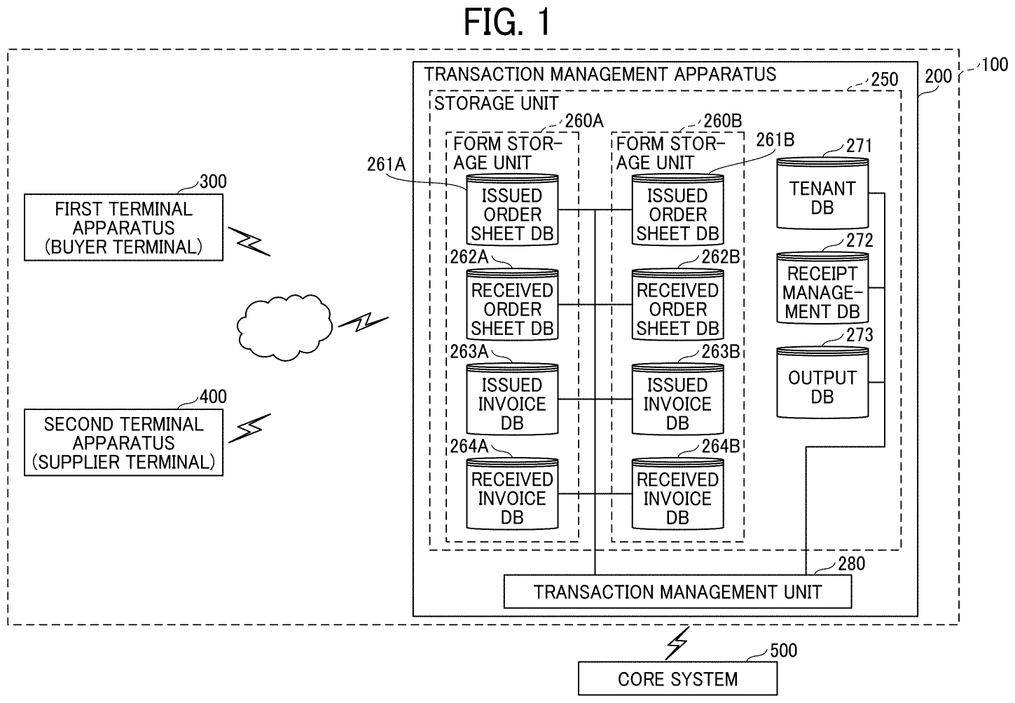

FIG. 1 is a diagram illustrating an example of the system configuration of a transaction management system according to a first embodiment of the present invention.

A transaction management system 100 of the first embodiment includes a transaction management apparatus 200, a first terminal apparatus 300, and a second terminal apparatus 400, which are connected to each other via a network, for example. The transaction management system 100 is an example of an information processing system.

In the transaction management system 100 of the first embodiment, the transaction management apparatus 200 manages form information exchanged between the first terminal apparatus 300 and the second terminal apparatus 400, which are used by businesses or individuals that conduct sales transactions, for example. The transaction management apparatus 200 is an example of an information processing apparatus.

In the first embodiment, the first terminal apparatus 300 is a terminal apparatus mainly used by a buyer in a sales transaction, and the second terminal apparatus 400 is a terminal apparatus mainly used by a supplier in the sales transaction. In the following description, the first terminal apparatus 300 and the second terminal apparatus 400 will also be described as the buyer terminal 300 and the supplier terminal 400, respectively.

Further, in the following description, a user of a service provided by the transaction management system 100 of the first embodiment may be described as a tenant. That is, a tenant in the first embodiment is a business or individual acting as the supplier or buyer, for example.

Further, in the following description, a tenant acting as the buyer will be described as Corporation A, and a tenant acting as the supplier will be described as B Corporation. Therefore, the buyer terminal 300 is managed by Corporation A. and the supplier terminal 400 is managed by B Corporation.

The transaction management apparatus 200 of the first embodiment includes a storage unit 250 and a transaction management unit 280. The storage unit 250 of the first embodiment includes form storage units 260A and 260B, a tenant database (DB) 271, a receipt management DB 272, and an output DB 273.

Each of the form storage units 260A and 260B stores the form information of a tenant. It is assumed in the first embodiment that the form storage unit 260A stores the form information of Corporation A, and that the form storage unit 260B stores the form information of B Corporation. In FIG. 1, the transaction management apparatus 200 includes the form storage units 260A and 260B. However, the form storage units included in the transaction management apparatus 200 are not limited thereto. The transaction management apparatus 200 includes respective form storage units 260 for all tenants of the transaction management system 100. The form information refers to the information described in a form such as a quotation, an order sheet, a statement of delivery, or an invoice. In the case of the invoice, for example, the form information includes information described in the invoice, such as the biller, the paver, the invoice amount, the payment due date, and the description information including the article name, the unit price, the quantity, and the price of each invoiced article, for example.

In the following description, the invoice and the order sheet will be described as examples of the form. Therefore, the form information of the first embodiment includes order sheet information representing the order sheet and invoice information representing the invoice. The order sheet information is an example of first form information, and the invoice information is an example of second form information.

The form storage unit 260A of the first embodiment includes an issued order sheet DB 261A, a received order sheet DB 262A, an issued invoice DB 263A, and a received invoice DB 264A.

The issued order sheet DB 261A stores issued order sheet information representing order sheets issued by Corporation A. The received order sheet DB 262A stores received order sheet information representing order sheets received by Corporation A.

The issued invoice DB 263A stores issued invoice information representing invoices issued by Corporation A. The received invoice DB 264A stores received invoice information representing invoices received by Corporation A.

The form storage unit 260B of the first embodiment includes an issued order sheet DB 261B, a received order sheet DB 262B, an issued invoice DB 263B, and a received invoice DB 264B.

The issued order sheet DB 261B stores issued order sheet information representing order sheets issued by B Corporation. The received order sheet DB 262B stores received order sheet information representing order sheets received by B Corporation.

The issued invoice DB 263B stores issued invoice information representing invoices issued by B Corporation. The received invoice DB 264B stores received invoice information representing invoices received by B Corporation.

In the following description, the issued order sheet DBs 261A and 261B will be described as the issued order sheet DBs 261 where no distinction is made therebetween. Similarly, the received order sheet DBs 262A and 262B, the issued invoice DBs 263A and 263B, and the received invoice DBs 264A and 264B will be described as the received order sheet DBs 262, the issued invoice DBs 263, and the received invoice DBs 264, respectively, where no distinction is made therebetween.

The tenant DB 271 stores information related to the tenants. The receipt management DB 272 stores information representing the storage locations of the forms received by the tenants. The output DB 273 stores information in a format compatible with a core system 500 outside the transaction management system 100.

In batch invoicing in which a supplier issues a batch invoice for a plurality of order sheets issued by a buyer, the transaction management unit 280 of the first embodiment manages the order sheet information representing the plurality of order sheets issued by the buyer and the invoice information representing the single invoice issued by the supplier in association with each other.

Further, according to the first embodiment, in installment invoicing in which a supplier issues invoices in installments for an order sheet issued to the supplier by a buyer, the transaction management unit 280 manages part of the order sheet information representing the order sheet issued by the buyer and the invoice information representing a corresponding one of the invoices issued by the supplier in association with each other. Part of the order sheet information corresponds to part of all descriptions (e.g., the article, the quantity, and the price) included in the description information described in the order sheet.

In the first embodiment, a plurality of order sheet information items and an invoice information item are thus managed in association with each other, facilitating the reconciliation work of the supplier in the batch invoicing for a plurality of order sheets. Further, in the first embodiment, an order sheet information item and a plurality of invoice information items are managed in association with each other, facilitating the reconciliation work of the supplier in the installment invoicing in which invoices are issued in installments for a single order. The first embodiment therefore improves the convenience in the reconciliation work.

In the example of FIG. 1, the transaction management apparatus 200 includes the storage unit 250. The configuration of the storage unit 250, however, is not limited thereto. Part or all of the databases included in the storage unit 250 may be included in an external apparatus. Further, the transaction management apparatus 200 may be implemented by a plurality of information processing apparatuses.

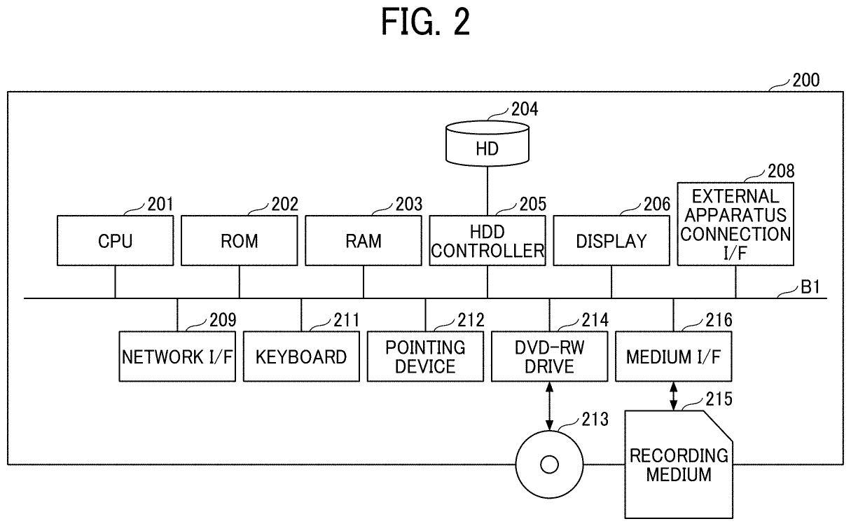

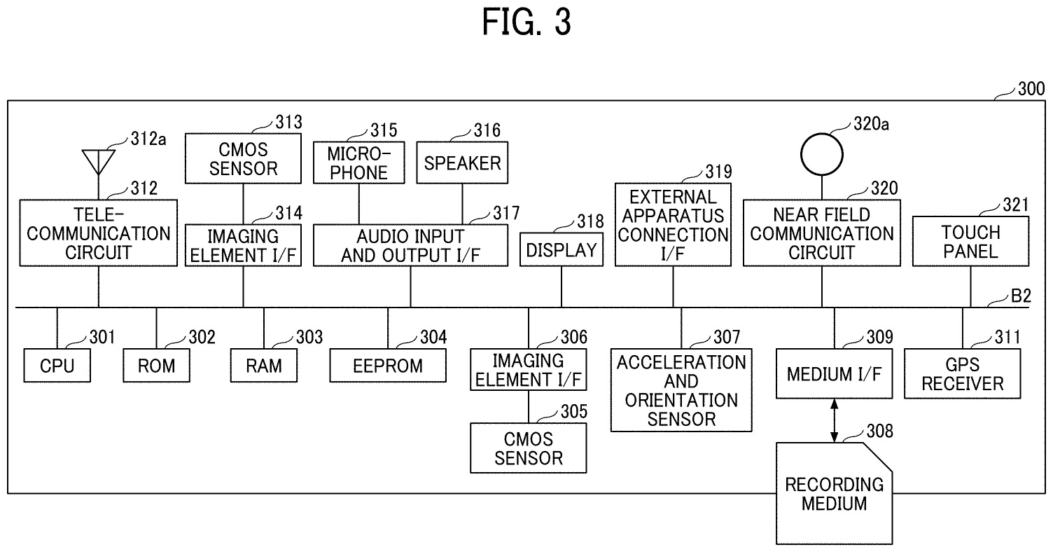

A hardware configuration of the information processing apparatus implementing the transaction management apparatus 200 and a hardware configuration of the first terminal apparatus 300 will be described with reference to FIGS. 2 and 3.

FIG. 2 is a diagram illustrating an example of the hardware configuration of the transaction management apparatus 200 of the first embodiment. The transaction management apparatus 200 is implemented by a computer. As illustrated in FIG. 2, the transaction management apparatus 200 includes a central processing unit (CPU) 201, a read only memory (ROM) 202, a random access memory (RAM) 203, a hard disk (HD) 204, a hard disk drive (HDD) controller 205, a display 206, an external apparatus connection interface (I/F) 208, a network I/F 209, a bus line B1, a keyboard 211, a pointing device 212, a digital versatile disk-rewritable (DVD-RW) drive 214, and a medium I/F 216.

The CPU 201 controls the overall operation of the transaction management apparatus 200. The ROM 202 stores a program used to drive the CPU 201, such as an initial program loader (IPL). The RAM 203 is used as a work area for the CPU 201. The HD 204 stores various data of programs, for example. The HDD controller 205 controls writing and reading of various data to and from the HD 204 under the control of the CPU 201. The display 206 displays various information such as a cursor, menus, windows, text, and images. The external apparatus connection I/F 208 is an interface for connecting the transaction management apparatus 200 to various external apparatuses. The external apparatuses in this case include a universal serial bus (USB) memory and a printer, for example. The network I/F 209 is an interface for performing data communication via a communication network. The bus line B1 includes an address bus and a data bus for electrically connecting the CPU 201 and the other components in FIG. 2 to each other.

The keyboard 211 is an input device including a plurality of keys for inputting text, numerical values, and various instructions, for example. The pointing device 212 is an input device used to select and execute various instructions, select a processing target, and move the cursor, for example. The DVD-RW drive 214 controls writing and reading of various data to and from a DVD-RW 213 as an example of a removable recording medium. The removable recording medium is not limited to the DVD-RW, and may be a DVD-recordable (DVD-R), for example. The medium I/F 216 controls writing (i.e., storage) and reading of data to and from a recording medium 215 such as a flash memory.

FIG. 3 is a diagram illustrating an example of the hardware configuration of the first terminal apparatus 300 of the first embodiment. The first terminal apparatus 300 and the second terminal apparatus 400 of the first embodiment may have a similar configuration. The following description of FIG. 3 will therefore focus on a hardware configuration of the first terminal apparatus 300 as an example of a terminal apparatus of the first embodiment.

The first terminal apparatus 300 of the first embodiment includes a CPU 301, a ROM 302, a RAM 303, an electrically erasable programmable read only memory (EEPROM) 304, a complementary metal oxide semiconductor (CMOS) sensor 305, an imaging element I/F 306, an acceleration and orientation sensor 307, a medium I/F 309, and a global positioning system (GPS) receiver 311.

The CPU 301 is an arithmetic processing device that controls the overall operation of the first terminal apparatus 300. The ROM 302 stores programs for the CPU 301 and a program used to drive the CPU 301 such as an IPL. The RAM 303 is used as a work area for the CPU 301. The EEPROM 304 writes or reads various data of a program for the terminal apparatus, for example, under the control of the CPU 301. The ROM 302, the RAM 303, and the EEPROM 304 are examples of storage devices of the first terminal apparatus 300.

The CMOS sensor 305 is a built-in imaging device that captures the image of a subject (mainly the image of a user) under the control of the CPU 301 to obtain image data. The CMOS sensor 305 may be replaced by another imaging device such as a charge coupled device (CCD) sensor.

The imaging element IF 306 is a circuit that controls the driving of the CMOS sensor 305. The acceleration and orientation sensor 307 includes various types of sensors such as an electromagnetic compass that detects geomagnetism, a gyrocompass, and an acceleration sensor. The medium i/F 309 controls data writing (i.e., storage) and reading to and from a recording medium 308 such as a flash memory. The GPS receiver 311 receives a GPS signal from a GPS satellite.

The first terminal apparatus 300 further includes a telecommunication circuit 312, an antenna 312a for the telecommunication circuit 312, a CMOS sensor 313, an imaging element I/F 314, a microphone 315, a speaker 316, an audio input and output I/F 317, a display 318, an external apparatus connection I/F 319, a near field communication circuit 320, an antenna 320a for the near field communication circuit 320, a touch panel 321, and a bus line B2.

The telecommunication circuit 312 is a circuit that communicates with another apparatus via a communication network. The CMOS sensor 313 is a built-in imaging device that captures the image of a subject under the control of the CPU 301 to obtain image data. The imaging element I/F 314 is a circuit that controls the driving of the CMOS sensor 313. The microphone 315 is a built-in circuit that converts sound into an electrical signal. The speaker 316 is a built-in circuit that converts an electrical signal into physical vibration to produce the sound of music or voice, for example. The audio input and output I/F 317 is a circuit that processes the input of an audio signal from the microphone 315 and the output of an audio signal to the speaker 316 under the control of the CPU 301.

The display 318 is a display device such as a liquid crystal or organic electroluminescence (EL) display, for example, which displays the image of the subject and various icons, for example. The external apparatus connection I/F 319 is an interface for connecting the first terminal apparatus 300 to various external apparatuses. The near field communication circuit 320 is a communication circuit conforming to a standard such as near field communication (NFC) or Bluetooth (registered trademark). The touch panel 321 is an input device for the user to operate the first terminal apparatus 300 by pressing the display 318. The display 318 is an example of a display included in the first terminal apparatus 300. The bus line B2 includes an address bus and a data bus for electrically connecting the CPU 301 and the other components in FIG. 3 to each other.

The first terminal apparatus (i.e., buyer terminal) 300 and the second terminal apparatus (i.e., supplier terminal) 400 of the first embodiment may have a hardware configuration similar to that of the transaction management apparatus 200.

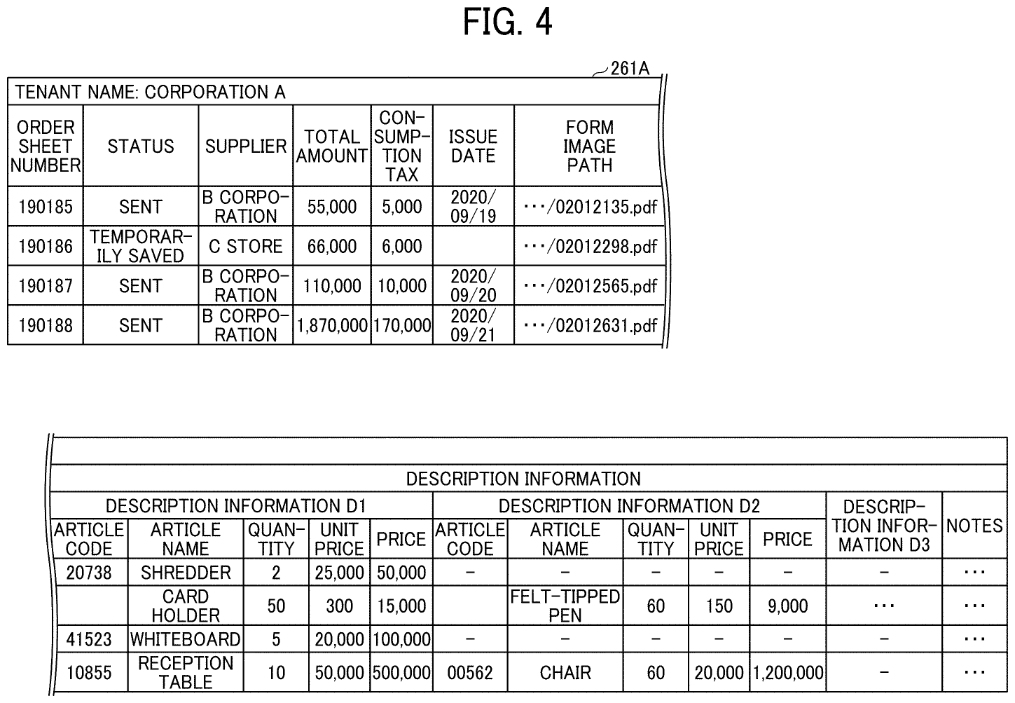

The databases included in the storage unit 250 will be described with reference to FIGS. 4 to 10.

FIG. 4 is a diagram illustrating an example of the issued order sheet DB 261 of the first embodiment. Specifically. FIG. 4 illustrates the issued order sheet DB 261A for Corporation A.

The issued order sheet DB 261A of the first embodiment includes information items “order sheet number,” “status,” “supplier,” “total amount,” “consumption tax,” “issue date,” “form image path,” and “description information.” for example. The item “order sheet number,” the tenant name, and the other items are associated with each other. The issued order sheet DB 261B may include information items similar to those of the issued order sheet DB 261A. In the following description, information including the value of the item “order sheet number,” the tenant name, and the values of the other items in the issued order sheet DB 261 will be described as the issued order sheet information.

When the order sheet information is created and transmitted to the transaction management apparatus 200 by the buyer terminal 300, the order sheet information is stored in the issued order sheet DB 261A as the issued order sheet information.

The value of the item “order sheet number” is identification information for identifying the order sheet. The value of the item “status” represents the status of the order sheet information. Specifically, when the order sheet information has been created and stored in the issued order sheet DB 261, the item “status” has a value “temporarily saved.” When the order sheet information has been transmitted to the supplier terminal 400, the item “status” has a value “sent.”

The value of the item “supplier” represents the name of the tenant acting as the supplier. The value of the item “total amount” represents the total amount included in the order sheet information. The value of the item “consumption tax” represents the amount of the consumption tax on the total amount. The value of the item “issue date” represents the creation date of the order sheet information (i.e., the issue date of the order sheet). The value of the item “form image path” represents the storage location of image data representing the created order sheet information, i.e., form image data.

The value of the item “description information” represents order descriptions included in the order sheet information. In the item “description information” in the example of FIG. 4, items such as “description information D1” and “description information D2” are associated with each other. The item “description information D1” includes items such as “article code,” “article name,” “quantity,” “unit price,” and “price.”

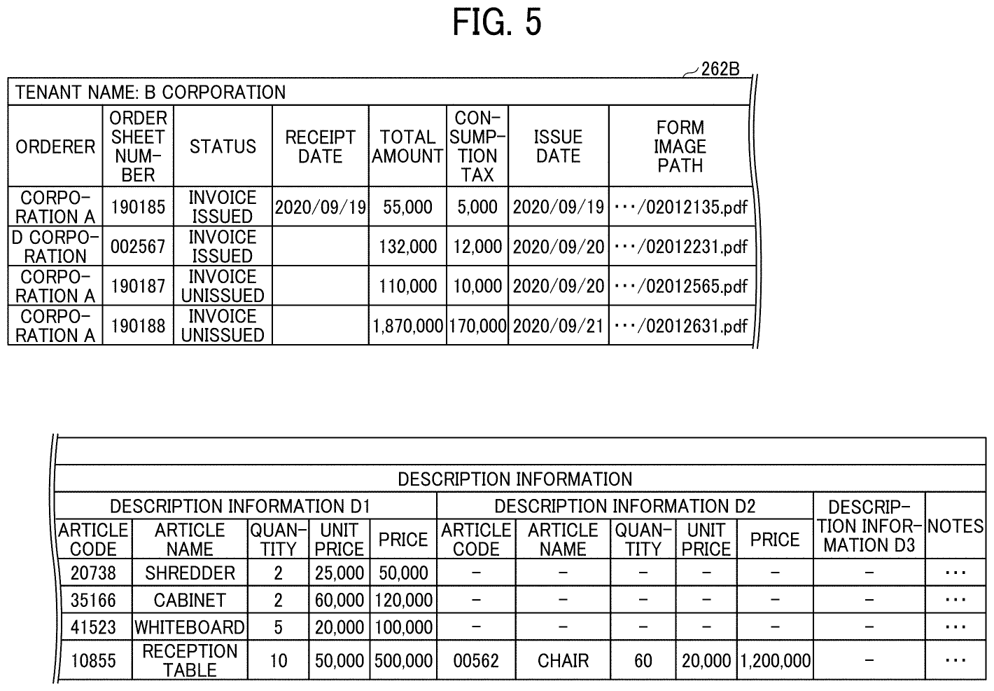

FIG. 5 is a diagram illustrating an example of the received order sheet DB 262 of the first embodiment. Specifically, FIG. 5 illustrates the received order sheet DB 262B for B Corporation.

The received order sheet DB 262B of the first embodiment includes information items “orderer,” “order sheet number,” “status,” “receipt date,” “total amount,” “consumption tax,” “issue date,” “form image path,” and “description information,” for example. The items “orderer” and “order sheet number” are associated with the other items. The received order sheet DB 262A may include information items similar to those of the received order sheet DB 262B. In the following description, information including the values of the items “orderer” and “order sheet number” and the values of the other items in the received order sheet DB 262 will be described as the received order sheet information.

When an operation of receiving the order sheet information transmitted from the transaction management apparatus 200 is performed on the supplier terminal 400, the order sheet information is stored in the received order sheet DB 262B as the received order sheet information.

The value of the item “orderer” represents the name of the tenant acting as the orderer, i.e., the tenant having created the order sheet information.

The value of the item “status” represents the status of the received order sheet information. For example, when the invoice information corresponding to the order sheet information has been transmitted to the buyer terminal 300, the item “status” has a value “invoice issued.” When the transmission of the invoice information has not been completed, the item “status” has a value “invoice unissued.”

The value of the item “receipt date” represents the date when the operation of receiving the order sheet information is performed on the supplier terminal 400, i.e., when the received order sheet information is stored in the received order sheet DB 262B.

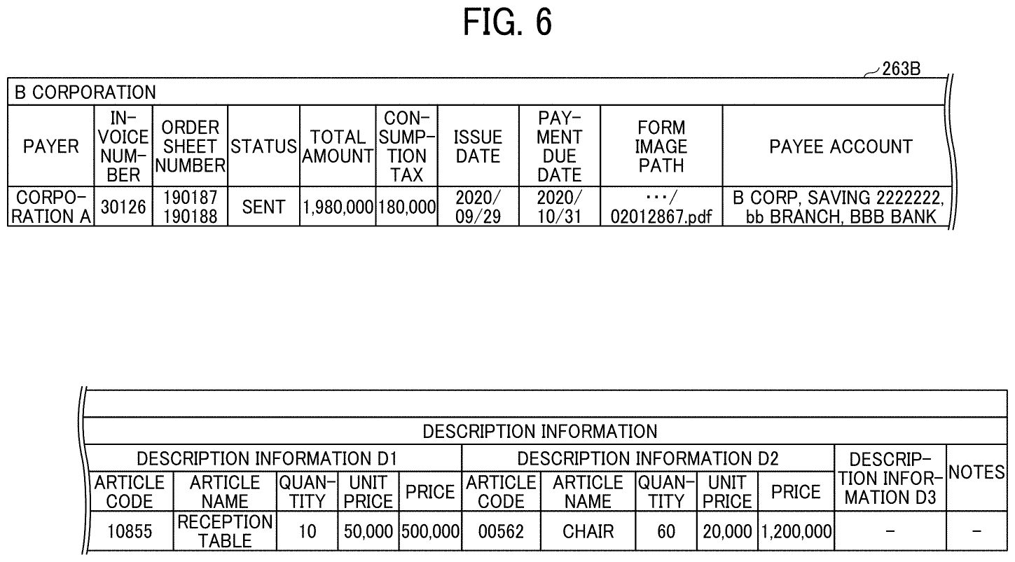

FIG. 6 is a diagram illustrating an example of the issued invoice DB 263 of the first embodiment. Specifically, FIG. 6 illustrates the issued invoice DB 263B for B Corporation.

The issued invoice DB 263B of the first embodiment includes information items “payer,” “invoice number,” “order sheet number,” “status,” “total amount,” “consumption tax,” “issue date,” “payment due date,” “form image path,” “payee account,” and “description information.” for example. The items “payer” and “invoice number” are associated with the other items. The issued invoice DB 263A may include information items similar to those of the issued invoice DB 263B. In the following description, information including the values of the items “payer” and “invoice number” and the values of the other items in the issued invoice DB 263 will be described as the issued invoice information.

When the invoice information is created and transmitted to the transaction management apparatus 200 by the supplier terminal 400, the invoice information is stored in the issued invoice DB 263B as the issued invoice information.

The value of the item “payer” represents the name of the tenant as the transmission destination of the invoice information, i.e., the tenant (i.e., orderer or buyer) who has created the order sheet information identified with the corresponding order sheet number. The value of the item “invoice number” is identification information for identifying the invoice.

The value of the item “status” represents the status of the invoice information. When the invoice information has been created and stored in the issued invoice DB 263, the item “status” has the value “temporarily saved.” When the invoice information has been transmitted to the buyer terminal 300 from the transaction management apparatus 200, the item “status” has the value “sent.” The value of the item “payee account” represents the payee account to which the total amount included in the invoice information is to be transferred.

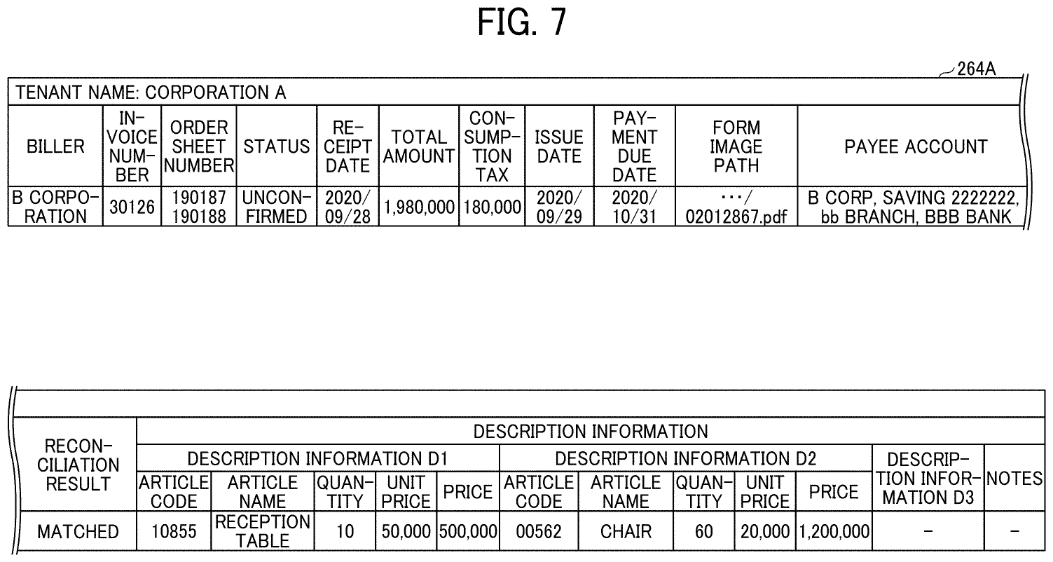

FIG. 7 is a diagram illustrating an example of the received invoice DB 264 of the first embodiment. Specifically, FIG. 7 illustrates the received invoice DB 264A for Corporation A.

The received invoice DB 264A of the first embodiment includes information items “biller,” “invoice number,” “order sheet number,” “status,” “receipt date,” “total amount,” “consumption tax,” “issue date,” “payment due date,” “form image path,” “payee account,” “reconciliation result,” and “description information,” for example. The items “biller” and “invoice number” are associated with the other items. The received invoice DB 264B may include information items similar to those of the received invoice DB 264A. In the following description, information including the values of the items “biller” and “invoice number” and the values of the other items in the received invoice DB 264 will be described as the received invoice information.

In the first embodiment, in response to storage of the received invoice information in the received invoice DB 264, a reconciliation process is executed in which the invoice information in the received invoice information identified with the invoice number is reconciled with the order sheet information identified with the order sheet number.

When an operation of receiving the invoice information is performed on the buyer terminal 300, the invoice information is stored in the received invoice information DB 264A as the received invoice information.

The value of the item “biller” represents the name of the tenant acting as the biller, i.e., the tenant having created the invoice information.

The value of the item “status” represents the status of the received invoice information. When the reconciliation result of the reconciliation process performed after the receipt of the invoice information has not been checked by the buyer, the item “status” has a value “unconfirmed.” When the reconciliation result has been checked by the buyer, the item “status” has a value “confirmed.” The values “unconfirmed” and “confirmed” of the item “status” may be “unchecked” and “checked,” respectively.

The value of the item “reconciliation result” represents the result of the reconciliation process executed by the transaction management unit 280 in response to receipt of the invoice information.

In the first embodiment, the item “reconciliation result” is included in the received invoice DB 264. Alternatively, the item “reconciliation result” may be included in all or one of the issued order sheet DB 261, the received order sheet DB 262, and the issued invoice DB 263. In this case, the value of the item “reconciliation result” may be updated in each database including the item “reconciliation result” after the storage of the received invoice information in the received invoice DB 264 and the execution of the reconciliation process by the transaction management unit 280.

Further, in the first embodiment, the form storage unit 260 may include, apart from the issued order sheet DB 261, the received order sheet DB 262, the issued invoice DB 263, and the received invoice DB 264, a database dedicated to storing reconciliation results.

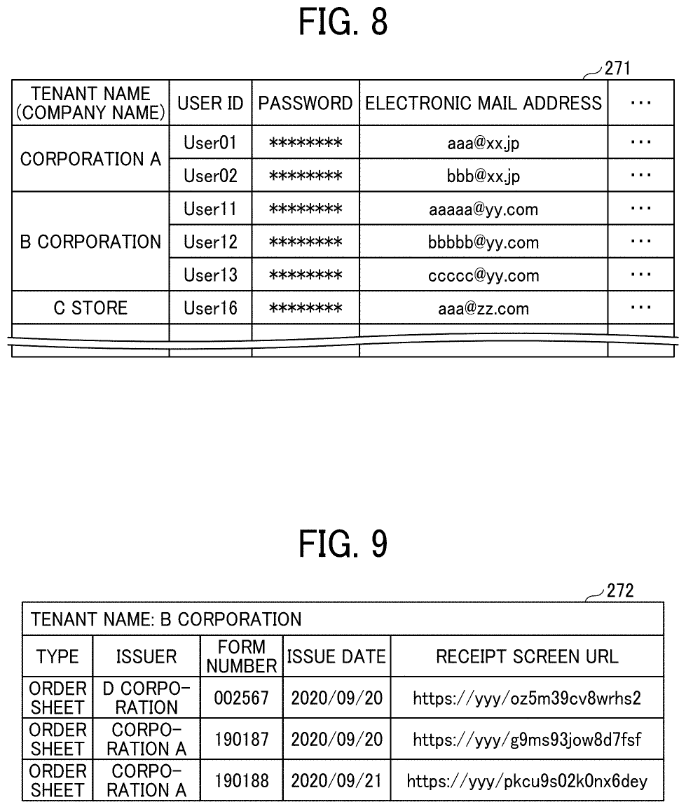

FIG. 8 is a diagram illustrating an example of the tenant DB 271 of the first embodiment. The tenant DB 271 of the first embodiment includes information items “tenant name,” “user identifier (ID),” “password,” and “electronic mail address,” for example. The item “tenant name” is associated with the other items. Information including the value of the item “tenant name” and the values of the other items in the tenant DB 271 may be described as the tenant information.

The value of the item “tenant name,” which represents the name of the tenant, is information for identifying the tenant. The values of the items “user ID” and “password” are used when the tenant logs in to the transaction management system 100. In the first embodiment, the value of the item “user ID” may be different between when the tenant is the buyer and when the tenant is the supplier.

The value of the item “electronic mail address” is information representing a contact address of the tenant, specifically the transmission destination of the order sheet information or the invoice information.

FIG. 9 is a diagram illustrating an example of the receipt management DB 272 of the first embodiment. The receipt management DB 272 of the first embodiment is provided for each tenant. The example of FIG. 9 illustrates the receipt management DB 272 for B Corporation.

The receipt management DB 272 includes information items “type,” “issuer,” “form number,” “issue date,” and “receipt screen uniform resource locator (URL),” for example. In the following description, information including the values of the items in the receipt management DB 272 may be described as the receipt management information.

The value of the item “type” represents the type of the form. The value of the item “issuer” represents the name of the tenant acting as the issuer of the form. The value of the item “form number” is identification information for identifying the form. When the type of the form is the order sheet, the form number is the order sheet number. When the type of the form is the invoice, the form number is the invoice number.

The value of the item “receipt screen URL” represents the URL of a screen for displaying a notification of receipt of the form.

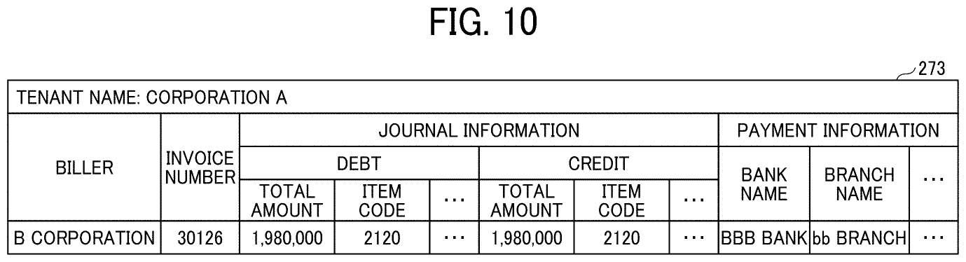

FIG. 10 is a diagram illustrating an example of the output DB 273 of the first embodiment. The output DB 273 of the first embodiment is provided for each tenant. The example of FIG. 10 illustrates the output DB 273 for Corporation A.

The output DB 273 of the first embodiment includes information items “biller.” “invoice number,” “journal information,” and “payment information,” for example. The items “biller” and “invoice number” are associated with the other items. In the following description, information including the values of the items “biller” and “invoice number” and the values of the other items in the output DB 273 may be described as the output information.

The output information may be in a format compatible with the core system 500, which communicates with the transaction management system 100. Specifically, the output information may be in the comma separated value (CSV) format. The core system 500 specifically includes an accounting system and a payment system, for example.

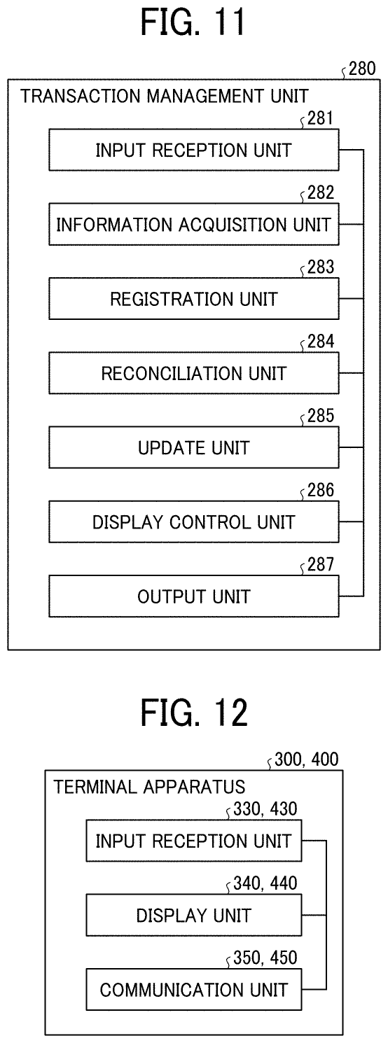

Functions of the apparatuses included in the transaction management system 100 of the first embodiment will be described with reference to FIGS. 11 and 12.

FIG. 11 is a diagram illustrating functions of the transaction management unit 280 included in the transaction management apparatus 200 of the first embodiment.

The transaction management unit 280 of the first embodiment includes an input reception unit 281, an information acquisition unit 282, a registration unit 283, a reconciliation unit 284, an update unit 285, a display control unit 286, and an output unit 287.

The input reception unit 281 receives various inputs to the transaction management apparatus 200. Specifically, the input reception unit 281 receives input of the order sheet information and the invoice information. The input reception unit 281 further receives various operations and requests from the buyer terminal 300 and the supplier terminal 400.

The information acquisition unit 282 acquires, from the storage unit 250, the information according to the operation or request received by the input reception unit 281.

The registration unit 283 stores each of various information items received by the input reception unit 281 into the corresponding one of the databases in the storage unit 250.

The update unit 285 updates the information stored in the storage unit 250 in accordance with the various operations received by the input reception unit 281.

The reconciliation unit 284 executes the reconciliation process of reconciling the order sheet information with the invoice information. Specifically, the reconciliation unit 284 stores the result of comparing the received invoice information with the order sheet information in the received invoice information identified with the order sheet number into the received invoice DB 264 as the reconciliation result.

The display control unit 286 controls the display on the buyer terminal 300 and the supplier terminal 400. Specifically, the display control unit 286 causes each of the buyer terminal 300 and the supplier terminal 400 to display various screens.

The output unit 287 outputs various information from the transaction management apparatus 200. Specifically, the output unit 287 outputs notifications to the buyer terminal 300 and the supplier terminal 400. The output unit 287 further outputs the output information stored in the output DB 273 to the core system 500.

FIG. 12 is a diagram illustrating functions of the first terminal apparatus (i.e., buyer terminal) 300 and the second terminal apparatus (i.e., supplier terminal) 400 of the first embodiment. The buyer terminal 300 of the first embodiment includes an input reception unit 330, a display unit 340, and a communication unit 350. Similarly, the supplier terminal 400 of the first embodiment includes an input reception unit 430, a display unit 440, and a communication unit 450.

The input reception unit 330 receives input of an operation or information to the buyer terminal 300. The display unit 340 displays various screens on the buyer terminal 300. The communication unit 350 performs communication between the buyer terminal 300 and the transaction management apparatus 200.

Similarly, the input reception unit 430 receives input of an operation or information to the supplier terminal 400. The display unit 440 displays various screens on the supplier terminal 400. The communication unit 450 performs communication between the supplier terminal 400 and the transaction management apparatus 200.

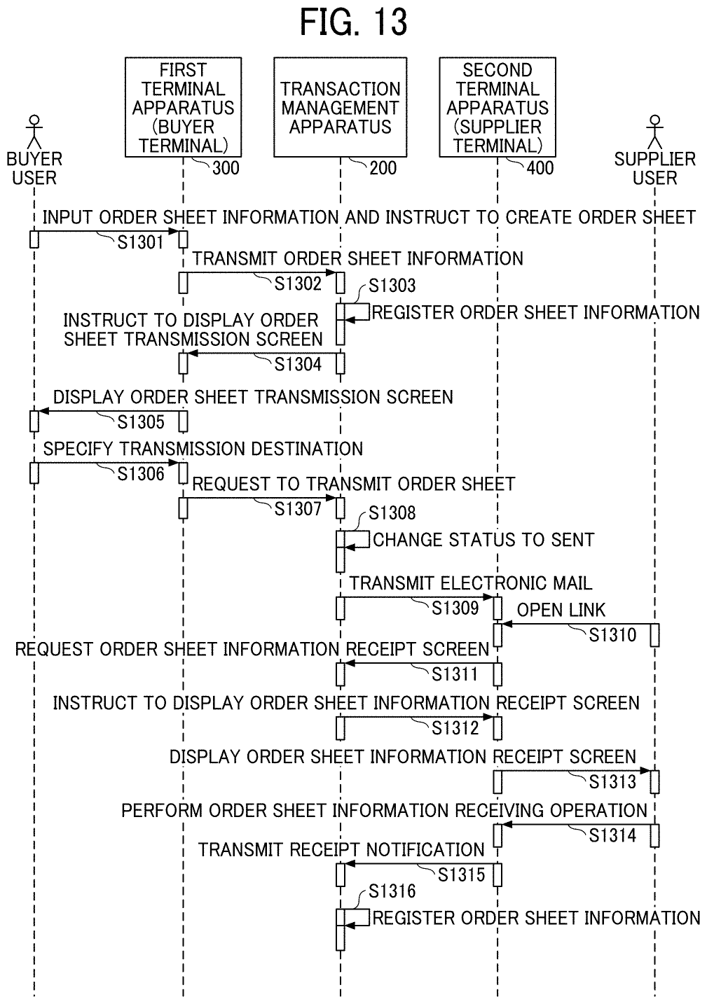

An operation of the transaction management system 100 of the first embodiment will be described with reference to FIG. 13.

FIG. 13 is a sequence diagram illustrating an operation of the transaction management system 100 of the first embodiment. FIG. 13 illustrates an operation of the transaction management system 100 performed when the buyer places an order to the supplier. It is assumed in the following description of FIG. 13 that Corporation A is the buyer, and that B Corporation is the supplier. In FIG. 13, a user of the buyer terminal 300 is illustrated as a buyer user, and a user of the supplier terminal 400 is illustrated as a supplier user.

In the transaction management system 100, the buyer terminal 300 receives user input of the order sheet information and an instruction to create the order sheet (step S1301), and transmits the input order sheet information to the transaction management apparatus 200 (step S1302).

In the transaction management apparatus 200, the registration unit 283 of the transaction management unit 280 stores the order sheet information received from the buyer terminal 300 in the issued order sheet DB 261A of the form storage unit 260A corresponding to Corporation A (step S1303).

Specifically, with the registration unit 283, the transaction management unit 280 stores the input information such as the supplier, the total amount, the consumption tax, the issue date, and the description information in the issued order sheet DB 261A in association with the order sheet number, the status, and the form image path, for example, as the issued order sheet information.

Further, in this process, the registration unit 283 generates the URL of an order sheet information receipt screen for receiving the issued order sheet information stored in the issued order sheet DB 261A, and registers the receipt management information in the receipt management DB 272. In the receipt management information, the type of the form (i.e., the order sheet), the issuer of the order sheet (i.e., Corporation A), the order sheet number, and the issue date are associated with each other. When the order sheet information is received by the supplier terminal 400, the receipt management information may be deleted and the URL may be disabled.

Then, in the transaction management apparatus 200, the display control unit 286 transmits a display instruction to the buyer terminal 300 to instruct to display an order sheet transmission screen (step S1304).

In response to receipt of the display instruction, the display unit 340 of the buyer terminal 300 displays the order sheet transmission screen (step S1305). Then, the buyer terminal 300 receives user specification of the transmission destination of the order sheet (step S1306), and transmits an order sheet transmission request to the transaction management apparatus 200 (step S1307).

In the transaction management apparatus 200, the update unit 285 updates the value of the item “status” of the order sheet information stored in the issued order sheet DB 261A to “sent” (step S1308).

Then, in the transaction management apparatus 200, the output unit 287 transmits an electronic mail to the supplier terminal 400 specified as the transmission destination (step S1309). The electronic mail contains information of the storage location of (i.e., the link to) the image data of the order sheet.

The above-described processes form an operation of transmitting the order sheet information from the buyer terminal 300 to the supplier terminal 400. The processes of step S1310 and the subsequent steps may be performed at a time separate from the time of performing the order sheet information transmission operation of steps S1301 to S1309.

Then, the supplier terminal 400 receives user selection of the link included in the received electronic mail (step S1310), and transmits a display request to the transaction management apparatus 200 to request to display the order sheet information receipt screen (step S1311).

In response to receipt of the display request, the display control unit 286 of the transaction management apparatus 200 transmits a display instruction to the supplier terminal 400 to instruct to display the order sheet information receipt screen (step S1312). In response to receipt of the display instruction, the supplier terminal 400 displays the order sheet information receipt screen (step S1313).

The supplier terminal 400 then receives a user operation of receiving the order sheet information (step S1314), and transmits a receipt notification to the transaction management apparatus 200 (step S1315).

In response to receipt of the receipt notification, the transaction management apparatus 200 stores the order sheet information in the received order sheet DB 262B as the received order sheet information (step S1316). The transaction management apparatus 200 may extract the order sheet information from order sheet image data of the order sheet received through a particular process such as an optical character reader (OCR) process, and may store the extracted order sheet information in the received order sheet DB 262B as the received order sheet information.

Specifically, in the transaction management apparatus 200, the information acquisition unit 282 acquires the order sheet information, which includes the tenant name, the order sheet number, the total amount, the consumption tax, the issue date, the form image path, and the description information, for example, from the issued order sheet DB 261A of the form storage unit 260A for the buyer. Then, in the transaction management apparatus 200, the registration unit 283 stores the order sheet information in the received order sheet DB 262B in association with the orderer (i.e., the tenant name) and the receipt date and the status of the order sheet information as the received order sheet information.

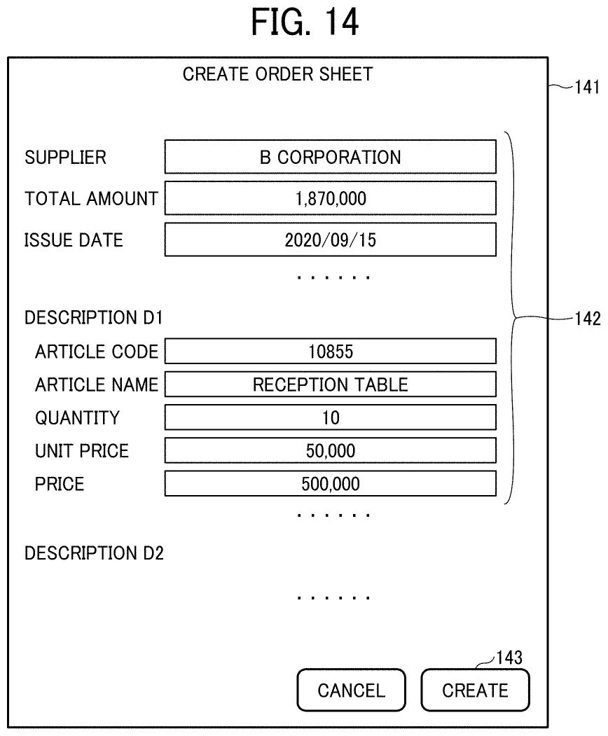

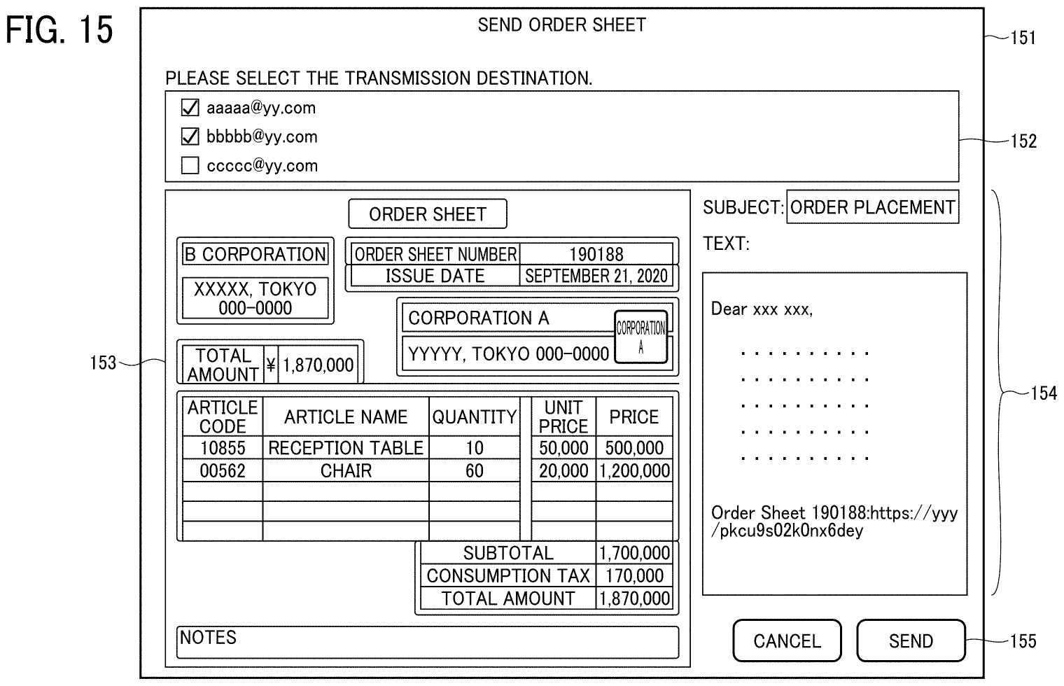

Display examples of the buyer terminal 300 and the supplier terminal 400 in the operation of FIG. 13 will be described with reference to FIGS. 14 to 17.

FIG. 14 is a diagram illustrating an example of an order sheet creation screen of the first embodiment. A screen 141 illustrated in FIG. 14 is an example of the order sheet creation screen displayed on the buyer terminal 300 at step S1301 in FIG. 13. The screen 141 includes an input field 142 and an operation button 143. The input field 142 is used to input the order sheet information. The operation button 143 is used to issue an instruction to transmit the order sheet information input in the input field 142 to the transaction management apparatus 200.

When the operation button 143 is operated on the buyer terminal 300 after the input of the order sheet information in the input field 142, the order sheet information is transmitted to the transaction management apparatus 200.

FIG. 15 is a diagram illustrating an example of the order sheet transmission screen of the first embodiment. A screen 151 illustrated in FIG. 15 is an example of the order sheet transmission screen displayed on the buyer terminal 300 at step S1305 in FIG. 13.

The screen 151 includes a selection field 152, display fields 153 and 154, and an operation button 155. The selection field 152 displays a list of electronic mail addresses as candidates for the transmission destination of the order sheet information. The transmission destination of the order sheet information is selected from the displayed list.

The display field 153 displays an order sheet image represented by the order sheet image data generated based on the order sheet information. The display field 154 displays the text of the electronic mail to be transmitted to the supplier terminal 400 in the transmission of the order sheet information. The operation button 155 is used to transmit the text of the electronic mail displayed in the display field 154 to the electronic mail address selected in the selection field 152.

When the operation button 155 is operated on the screen 151, the buyer terminal 300 transmits a transmission instruction to the transaction management apparatus 200 to instruct to transmit the electronic mail displayed in the display field 154 to the transmission destination.

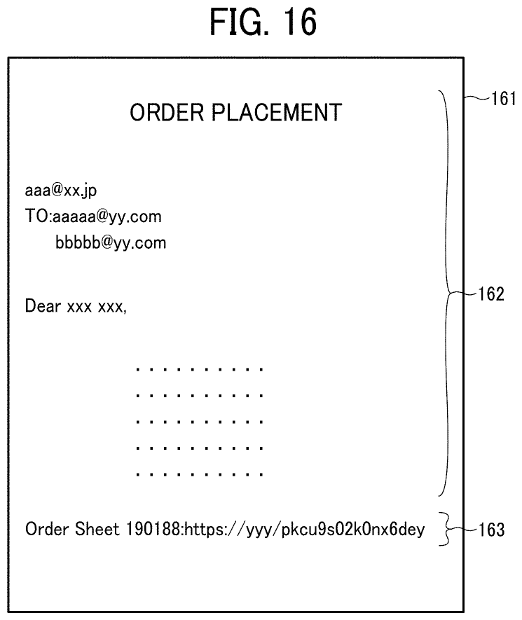

FIG. 16 is a diagram illustrating an example of an electronic mail screen of the first embodiment. A screen 161 illustrated in FIG. 16 is an example of the electronic mail screen displayed on the supplier terminal 400 at step S1310 in FIG. 13.

The screen 161 displays an electronic mail text 162 and a URL 163. The electronic mail text 162 may include text data indicating that the order sheet information has been transmitted. The URL 163 is a receipt screen URL stored in the receipt management DB 272.

When the URL 163 is selected on the screen 161, the supplier terminal 400 transmits a receipt screen display request to the transaction management apparatus 200.

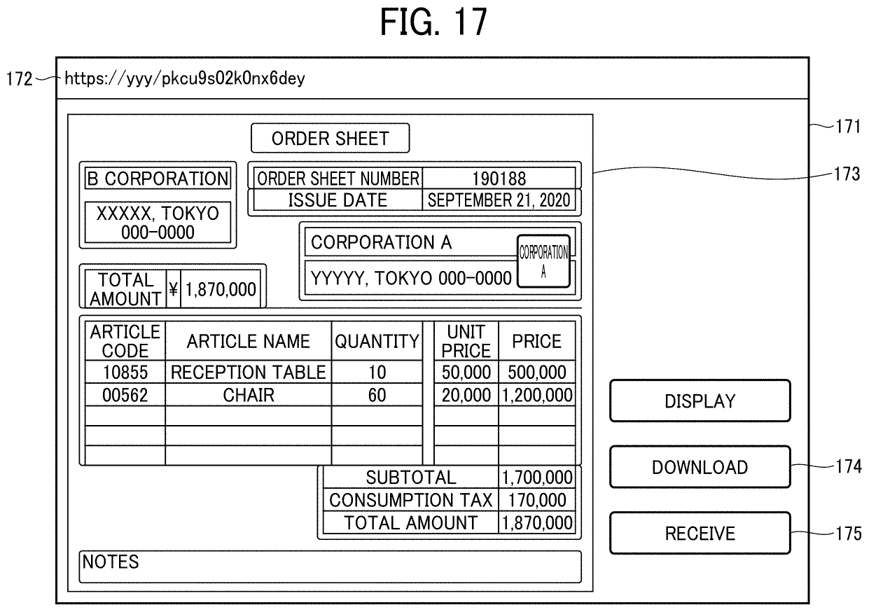

FIG. 17 is a diagram illustrating an example of the order sheet information receipt screen of the first embodiment. A screen 171 illustrated in FIG. 17 is an example of the order sheet information receipt screen displayed on the supplier terminal 400 at step S1313 in FIG. 13.

The screen 171 includes display fields 172 and 173 and operation buttons 174 and 175. The display field 172 displays the receipt screen URL. The display field 173 displays the order sheet image.

The operation button 174 is used to download the order sheet image data representing the order sheet image displayed in the display field 173 to the supplier terminal 400. The operation button 175 is used to transmit a notification to the transaction management apparatus 200 to notify that the order sheet information has been received.

When the operation button 175 is operated, the supplier terminal 400 transmits the order sheet information receipt notification to the transaction management apparatus 200.

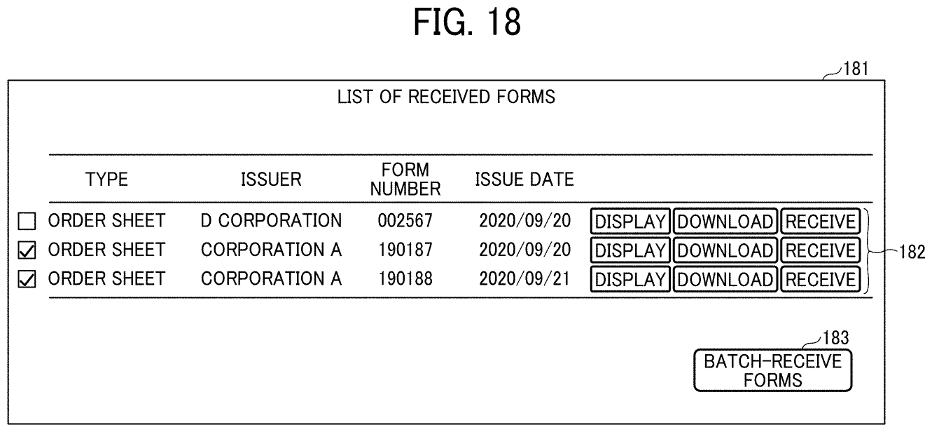

FIG. 18 is a diagram illustrating another example of the order sheet information receipt screen of the first embodiment. A screen 181 illustrated in FIG. 18 is another example of the order sheet information receipt screen displayed on the supplier terminal 400 at step S1313 in FIG. 13.

The screen 181 illustrated in FIG. 18 includes a display field 182 and an operation button 183. The display field 182 displays a list of order sheet information items of order sheets issued to the supplier terminal 400. In the first embodiment, the same receipt screen URL may be associated with the respective order sheet numbers in the receipt management DB 272 to display the screen 181 on the supplier terminal 400.

When the operation button 183 is operated on the screen 181 after the selection of the order sheet information items to be received in the display field 182, the selected order sheet information items are stored in the received order sheet DB 262 as the received order sheet information. The first embodiment thus enables batch receipt of a plurality of order sheet information items.

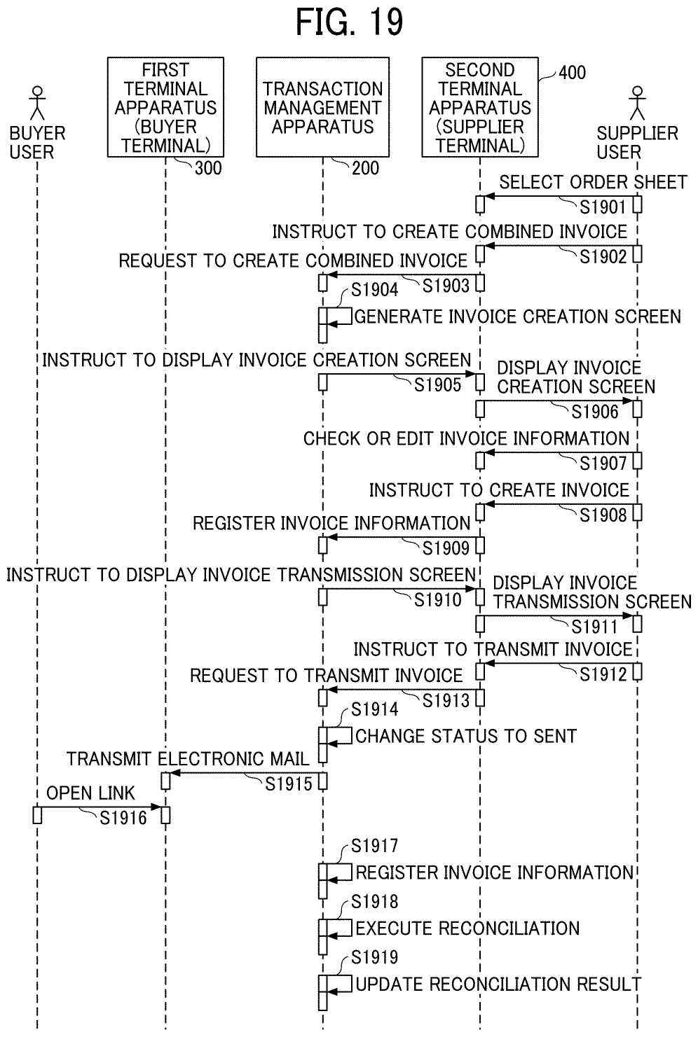

The issuance of the invoice by the supplier having received the order sheet information and the reconciliation will be described with reference to FIG. 19.

FIG. 19 is a sequence diagram illustrating another operation of the transaction management system 100 of the first embodiment.

In the transaction management system 100, the supplier terminal 400 displays a screen displaying a list of received order sheet information items, and receives user selection of order sheet information items for a combined invoice (step S1901). Then, the supplier terminal 400 receives a user instruction to create the combined invoice (step S1902), and transmits a creation request to the transaction management apparatus 200 to request to create the combined invoice (step S1903).

In response to receipt of the creation request, the display control unit 286 of the transaction management apparatus 200 generates screen data for displaying an invoice creation screen for creating the combined invoice (step S1904). In this process, the display control unit 286 generates invoice information by referring to the order sheet information items selected by the supplier terminal 400, and generates the screen data of the invoice creation screen for creating the combined invoice, which includes the generated invoice information.

The transaction management apparatus 200 then transmits a display instruction to the supplier terminal 400 to instruct to display the invoice creation screen (step S1905).

In response to receipt of the display instruction, the display unit 450 of the supplier terminal 400 displays the invoice creation screen (step S1906).

The supplier terminal 400 then receives a user operation of checking or editing the invoice information on the invoice creation screen (step S1907), and receives a user instruction to create the combined invoice (step S1908).

In response to receipt of the combined invoice creation instruction by the supplier terminal 400, the registration unit 283 of the transaction management apparatus 200 stores the invoice information in the issued invoice DB 263B as the issued invoice information (step S1909).

Specifically, the registration unit 283 generates the issued invoice information by associating items included in the order sheet information, such as the order sheet number, the total amount, the consumption tax, and the description information, with the payer, the invoice number, the status, the payment due date, the payee account, the issue date, and the form image path. The registration unit 283 then stores the generated issued invoice information in the issued invoice DB 263B.

The payer is Corporation A, i.e., the issuer of the order sheets. The invoice number may be assigned when the issued invoice information is stored in the issued invoice DB 263B. In this case, a combined invoice is created for a plurality of order sheets. Therefore, the invoice number is associated with the respective order sheet numbers of the plurality of order sheets for combined invoicing. When the issued invoice information is registered in the issued invoice DB 263B, the item “status” has the value “temporarily saved.”

The payment due date and the payee account are input on the invoice creation screen for creating the combined invoice. The issue date represents the date when the issued invoice information is stored in the issued invoice DB 263B. The form image path represents the storage location of combined invoice image data represented by combined invoice information.

Further, in this process, the registration unit 283 generates the URL of a receipt screen for receiving the issued invoice information stored in the issued invoice DB 263B, and registers the receipt management information in the receipt management DB 272 for B corporation. In the receipt management information, the type of the form (i.e., the invoice), the issuer of the invoice (i.e., B Corporation), the invoice number, and the issue date are associated with each other.

Then, in the transaction management apparatus 200, the display control unit 286 instructs the supplier terminal 400 to display an invoice transmission screen for transmitting the combined invoice (step S1910).

In the supplier terminal 400, the display unit 450 displays the invoice transmission screen for transmitting the combined invoice (step S1911). Then, the supplier terminal 400 receives user specification of the transmission destination of the combined invoice and an instruction to transmit the combined invoice (step S1912), and transmits a combined invoice transmission request to the transaction management apparatus 200 to request to transmit the combined invoice to the transmission destination (step S1913). In this case, the transmission destination of the combined invoice is Corporation A, i.e., the issuer of the order sheets corresponding to the order sheet information items.

In response to receipt of the transmission request, the update unit 285 of the transaction management apparatus 200 changes the status of the issued invoice information stored in the issued invoice DB 263B to “sent” (step S1914).

Then, in the transaction management apparatus 200, the output unit 287 transmits an electronic mail to the buyer terminal 300 specified as the transmission destination (step S1915). The electronic mail contains information of the storage location of (i.e., the link to) the image data of the combined invoice.

The above-described processes form an operation of transmitting the combined invoice information from the supplier terminal 400 to the buyer terminal 300. The processes of step S1916 and the subsequent steps may be performed at a time separate from the time of performing the combined invoice information transmission operation of steps S1901 to S1915.

Then, the buyer terminal 300 receives user selection of the link included in the received electronic mail (step S1916), and transmits a display request to the transaction management apparatus 200 to request to display an invoice information receipt screen.

An operation in FIG. 19 performed after the transaction management apparatus 200 receives the request to display the invoice information receipt screen is similar to that of steps S1312 to S1316 in FIG. 13 except that the order sheet information is replaced by the invoice information, and thus detailed description thereof will be omitted here.

In response to receipt of the display request, the display control unit 286 of the transaction management apparatus 200 transmits a receipt screen display instruction to the buyer terminal 300 to cause the buyer terminal 300 to display the invoice information receipt screen. In response to receipt of a user operation of receiving the invoice information, the buyer terminal 300 transmits a receipt notification to the transaction management apparatus 200.

Then, in response to receipt of the receipt notification from the buyer terminal 300, the registration unit 283 of the transaction management apparatus 200 stores the invoice information in the received invoice DB 264A as the received invoice information (step S1917).

Specifically, the information acquisition unit 282 of the transaction management apparatus 200 acquires, from the issued invoice DB 263B of the form storage unit 260B for the buyer, the invoice information including the tenant name, the invoice number, the total amount, the consumption tax, the issue date, the form image path, and the description information, for example.

Then, the registration unit 283 of the transaction management apparatus 200 stores the invoice information in the received invoice DB 264A in association with the biller (i.e., the tenant name) and the receipt date, the status, and the reconciliation result of the invoice information as the received order sheet information.

In this case, the status of the received invoice information is “unconfirmed.” and the reconciliation result of the received invoice information is “unreconciled.”

Then, in response to storage of the received invoice information in the received invoice DB 264A, the reconciliation unit 284 of the transaction management apparatus 200 executes the reconciliation process (step S1918). Details of the process of the reconciliation unit 284 at step S1918 will be described later.

Then, in accordance with the result of the process of the reconciliation unit 284, the update unit 285 of the transaction management apparatus 200 updates the reconciliation result of the received invoice information stored in the received invoice DB 264A (step S1919).

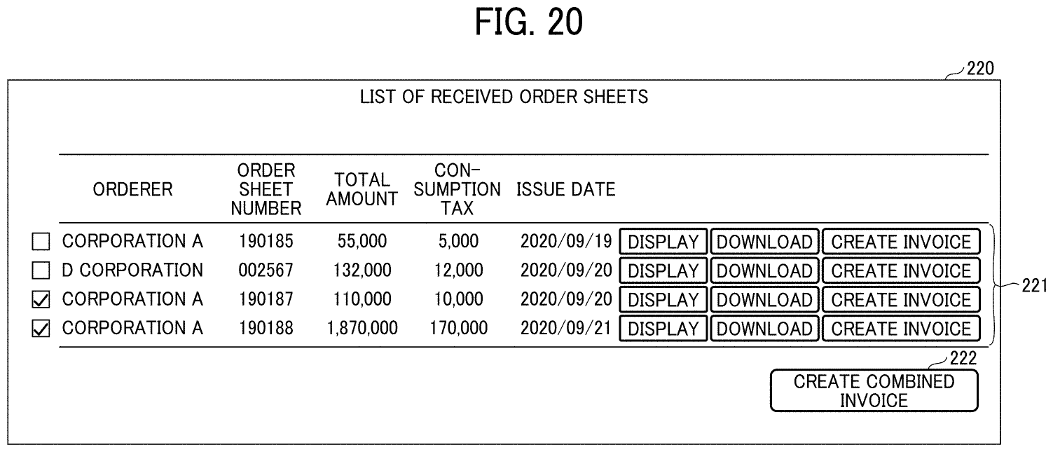

Display examples in the operation illustrated in FIG. 19 will be described with reference to FIGS. 20 to 23.

FIG. 20 is a diagram illustrating an example of an order sheet list screen of the first embodiment. A screen 220 illustrated in FIG. 20 is an example of the screen displayed on the supplier terminal 400 at step S1901 in FIG. 19.

The screen 220 illustrated in FIG. 20 includes a display field 221 and an operation button 222. The display field 221 displays a list of order sheet information items, each of which is associated with an operation button for downloading the order sheet information item and an operation button for creating an invoice corresponding to the order sheet information item, for example.

The operation button 222 is used to transmit an instruction to create the combined invoice information corresponding to the order sheet information items selected from the order sheet information items displayed in the list.

In the display field 221 in the example of FIG. 20, the order sheet information items with the tenant name “Corporation A” and order sheet numbers “190187” and “190188” are selected. In this case, the order sheet information items selectable at one time are those with the same tenant name.

When the operation button 222 is operated in this state, the supplier terminal 400 transmits an instruction to the transaction management apparatus 200 to instruct to create the combined invoice information corresponding to the order sheet information items with the order sheet numbers “190187” and “190188.”

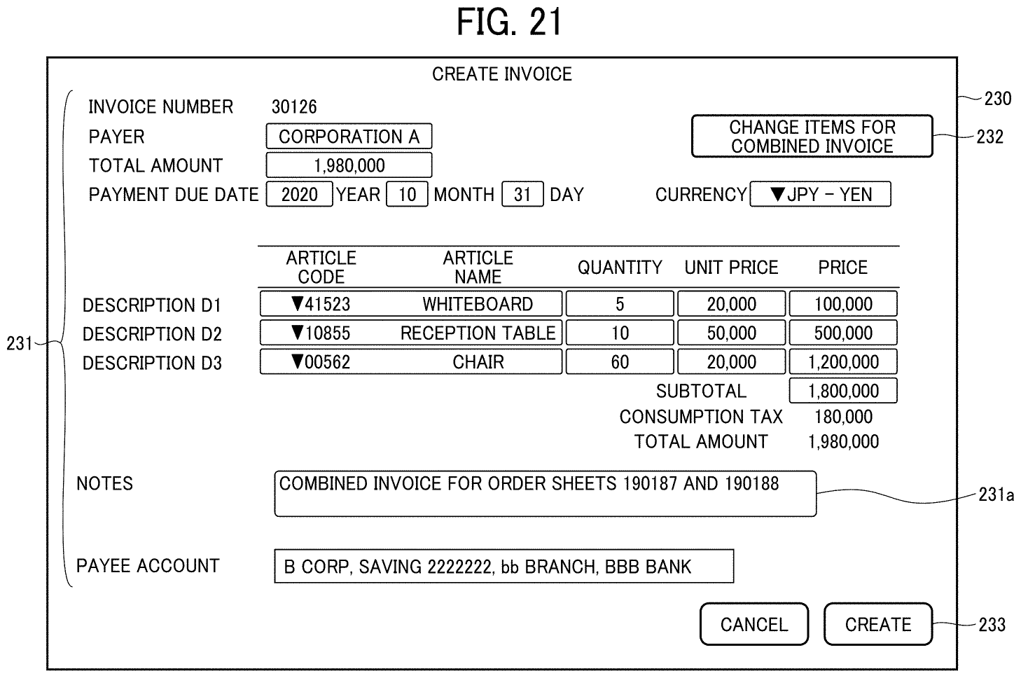

FIG. 21 is a diagram illustrating an example of the invoice creation screen of the first embodiment. A screen 230 illustrated in FIG. 21 is an example of the invoice creation screen displayed on the supplier terminal 400 at step S1906 in FIG. 19.

The screen 230 includes a display field 231 and operation buttons 232 and 233. The display field 231 displays input fields for inputting the invoice information. The operation button 232 is used to edit the invoice information displayed in the display field 231. The operation button 233 is used to transmit the instruction to create the combined invoice.

The display field 231 displays information input on the supplier terminal 400 such as the payment due date and the payee account and the description information acquired from the order sheet information items identified with the order sheet numbers “190187” and “190188.” The total amount displayed in the display filed 231 is the sum of the total amount included in the order sheet information item identified with the order sheet number “190187” and the total amount included in the order sheet information item identified with the order sheet number “190188.”

A note field 231a included in the display field 231 may display a message indicating that the current invoice is for combined invoicing for the order sheets with the order sheet numbers “190187” and “190188.”

When the operation button 232 is operated on the screen 230, the supplier terminal 400 displays an edit screen for changing the order sheet information items for the combined invoicing. The edit screen may be displayed on the screen 230 in a popup window, or may be displayed as a screen transitioned from the screen 230.

Further, when the operation button 233 is operated on the screen 230, the supplier terminal 400 transitions the screen 230 to the invoice transmission screen.

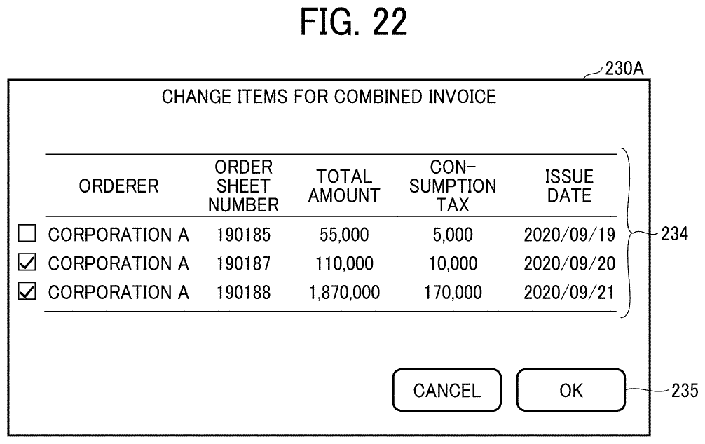

FIG. 22 is a diagram illustrating an example of the edit screen of the first embodiment. A screen 230A illustrated in FIG. 22 is an example of the edit screen displayed on the supplier terminal 400 at step S1907 in FIG. 19.

The screen 230A includes a display field 234 and an operation button 235. The display field 234 displays a list of order sheet information items as candidates for the combined invoicing. Specifically, the display field 234 displays a list of order sheet information items including the orderer matching the payer displayed on the screen 230 in FIG. 21. Since the payer is Corporation A on the screen 230 in FIG. 21, the display field 234 displays a list of order sheet information items including Corporation A as the orderer.

When the operation button 235 is operated after the selection of the order sheet information items in the display field 234, the supplier terminal 400 updates the display of the display field 231 on the screen 230 in FIG. 21 in accordance with the order sheet information items selected in the display field 234.

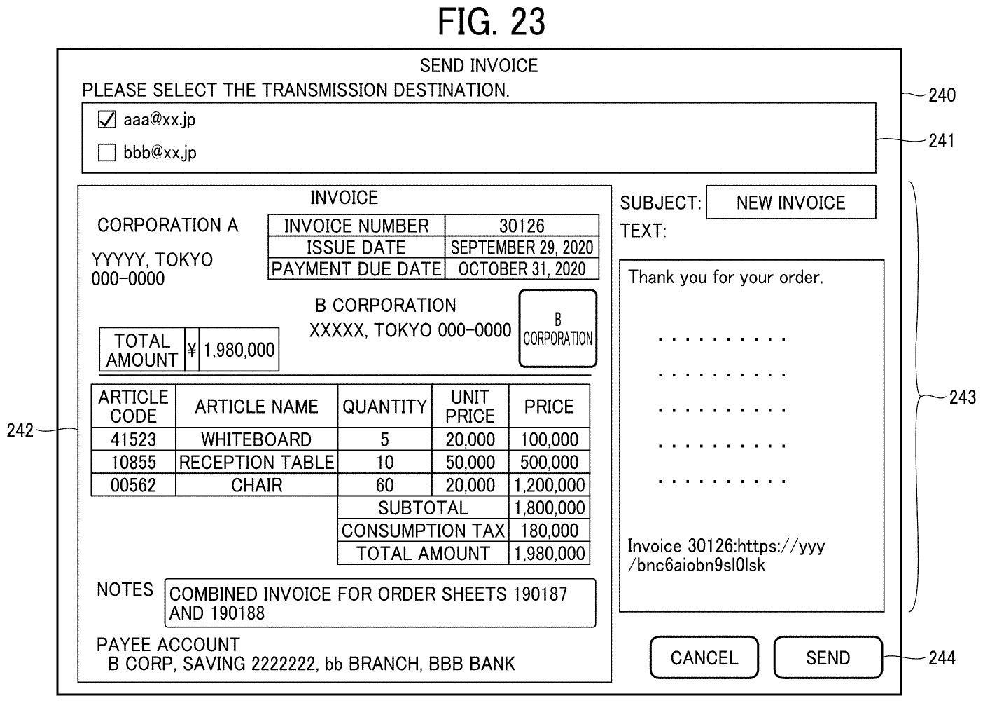

FIG. 23 is a diagram illustrating an example of the invoice transmission screen of the first embodiment for transmitting the combined invoice. A screen 240 illustrated in FIG. 23 is an example of the invoice transmission screen for transmitting the combined invoice displayed at step S1911 in FIG. 19.

The screen 240 includes a selection field 241, display fields 242 and 243, and an operation button 244. The selection field 241 displays a list of electronic mail addresses as candidates for the transmission destination of the invoice information. The transmission destination of the invoice information is selected from the displayed list.

The display field 242 displays an invoice image represented by the invoice image data generated based on the invoice information. The display field 243 displays the text of the electronic mail to be transmitted to the buyer terminal 300 in the transmission of the invoice information. The operation button 244 is used to transmit the text of the electronic mail displayed in the display field 243 to the electronic mail address selected in the selection field 241.

When the operation button 244 is operated on the screen 240, the supplier terminal 400 transmits an instruction to the transaction management apparatus 200 to instruct to transmit the electronic mail to the transmission destination displayed in the selection field 241.

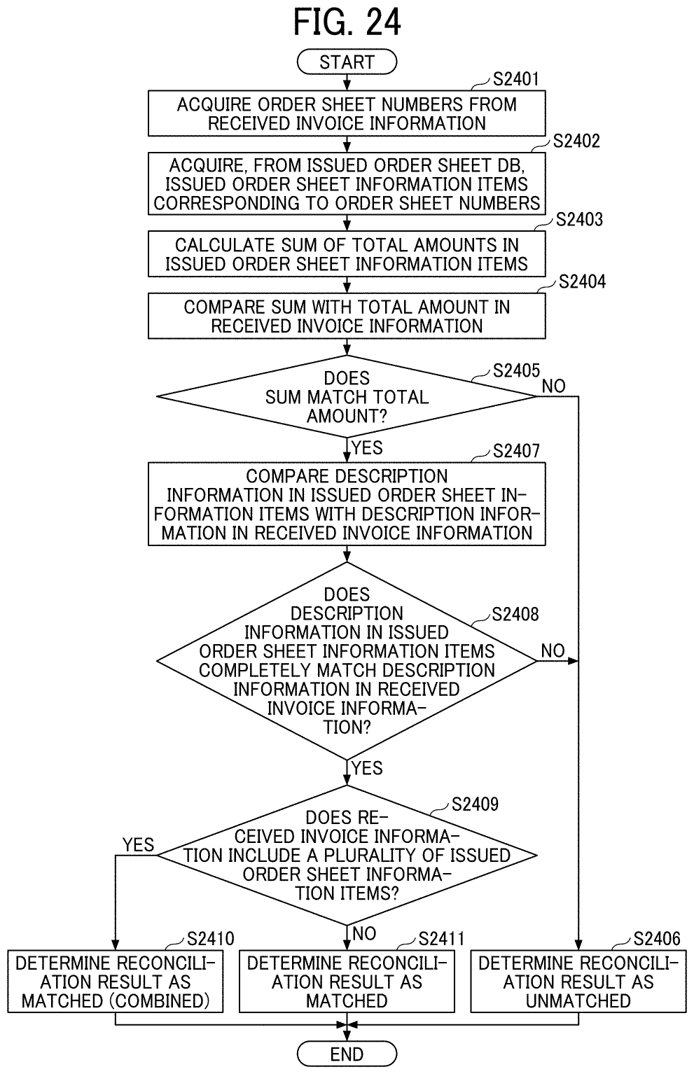

A process of the reconciliation unit 284 of the first embodiment will be described with reference to FIG. 24.

FIG. 24 is a flowchart illustrating a process of the reconciliation unit 284 of the first embodiment. FIG. 24 illustrates details of the process of the reconciliation unit 284 at step S1918 in FIG. 19.

The reconciliation unit 284 of the first embodiment acquires the order sheet numbers included in the received invoice information stored in the received invoice DB 264A at step S1917 (step S2401).

The reconciliation unit 284 then refers to the issued order sheet DB 261A and acquires therefrom the issued order sheet information items corresponding to the order sheet numbers acquired at step S2401 (step S2402). Then, the reconciliation unit 284 calculates the amount of the sum of the total amounts included in the acquired issued order sheet information items (step S2403).

The reconciliation unit 284 then compares the calculated amount of the sum with the total amount included in the received invoice information (step S2404), and determines whether the amount of the sum matches the total amount (step S2405).

If it is determined at step S2405 that the amount of the sum does not match the total amount (NO at step S2405), the reconciliation unit 284 determines the reconciliation result of the received invoice information as “unmatched” (step S2406), and completes the reconciliation process.

If it is determined at step S2405 that the amount of the sum matches the total amount (YES at step S2405), the reconciliation unit 284 compares the description information included in the issued order sheet information items with the description information included in the received invoice information (step S2407). The reconciliation unit 284 then determines whether the description information in the issued order sheet information items completely matches the description information in the received invoice information (step S2408).

If it is determined at step S2408 that the description information in the issued order sheet information items does not completely match the description information in the received invoice information (NO at step S2408), the reconciliation unit 284 proceeds to step S2406.

If it is determined at step S2408 that the description information in the issued order sheet information items completely matches the description information in the received invoice information (YES at step S2408), the reconciliation unit 284 determines whether the received invoice information includes a plurality of issued order sheet information items (step S2409). If it is determined at step S2409 that the received invoice information includes a plurality of issued order sheet information items (YES at step S2409), the reconciliation unit 284 determines the reconciliation result of the received invoice information as “matched (combined)” (step S2410), and completes the reconciliation process.

If it is determined at step S2409 that the received invoice information does not include a plurality of issued order sheet information items (NO at step S2409), the reconciliation unit 284 determines the reconciliation result of the received invoice information as “matched” (step S2411), and completes the reconciliation process. The distinction between the reconciliation results “matched (combined)” and “matched” may not be made. That is, if it is determined at step S2408 that the description information in the issued order sheet information items completely matches the description information in the received invoice information, the reconciliation unit 284 may determine the reconciliation result as “matched” and complete the reconciliation process, skipping the determination process of step S2409.

The above-described steps form the reconciliation process of the reconciliation unit 284.

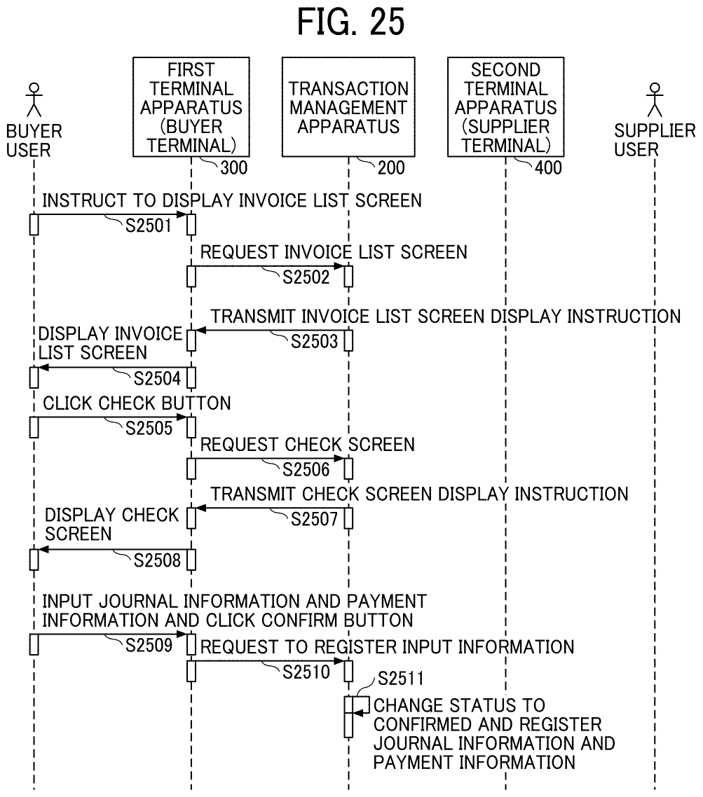

An operation of checking the received invoice information by the buyer terminal 300 will be described with reference to FIG. 25.

FIG. 25 is a sequence diagram illustrating another operation of the transaction management system 100 of the first embodiment.

In the transaction management system 100, the buyer terminal 300 receives a user instruction to display the invoice list screen (step S2501), and transmits an invoice list screen display request to the transaction management apparatus 200 (step S2502). In response to receipt of the display request, the display control unit 286 of the transaction management apparatus 200 transmits an invoice list screen display instruction to the buyer terminal 300 (step S2503).

In response to receipt of the display instruction from the transaction management apparatus 200, the display unit 340 of the buyer terminal 300 displays the invoice list screen (step S2504).

The buyer terminal 300 then receives user selection of a check button on the invoice list screen (step S2505), and transmits a check screen display request to the transaction management apparatus 200 (step S2506).

In response to receipt of the display request, the transaction management apparatus 200 transmits a check screen display instruction to the buyer terminal 300 (step S2507). In response to receipt of the display instruction, the buyer terminal 300 displays the check screen (step S2508).

The buyer terminal 300 then receives user input of information such as the journal information and the payment information and user selection of a confirm button (step S2509), and transmits the input information and a request to register the information to the transaction management apparatus 200 (step S2510).

In the transaction management apparatus 200, the update unit 285 changes the status of the checked received invoice information to “confirmed” from “unconfirmed,” and the registration unit 283 stores, in the output DB 273, the output information including the input information such as the journal information and the payment information (step S2511).

Specifically, the registration unit 283 acquires the invoice number and the biller from the checked received invoice information, generates the output information by associating the invoice number and the biller with the input information such as the journal information and the payment information, and stores the generated output information in the output DB 273.

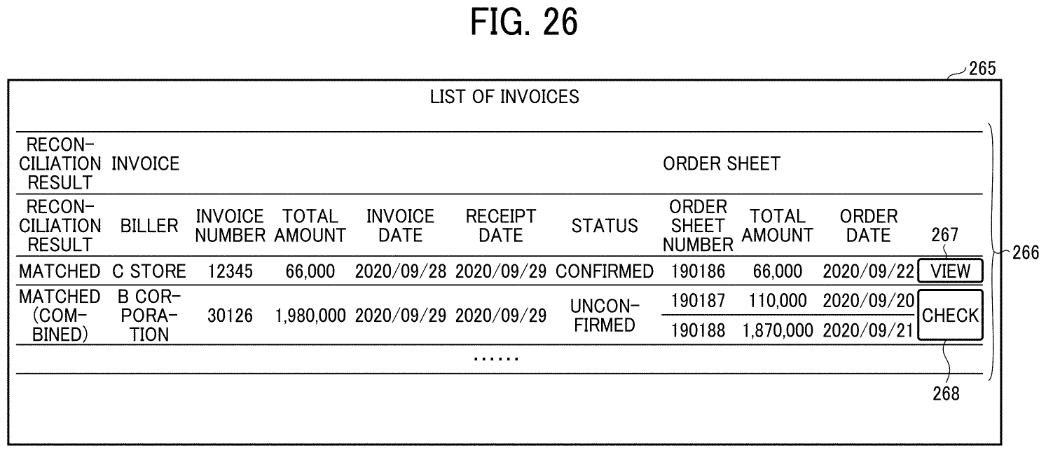

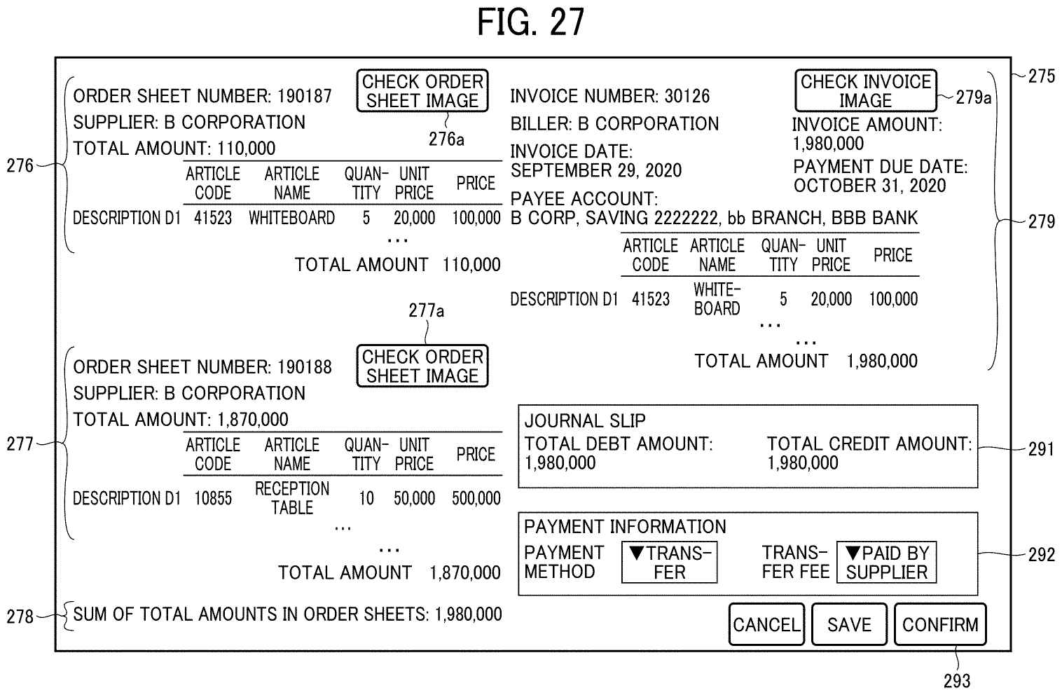

Display examples in the operation illustrated in FIG. 25 will be described with reference to FIGS. 26 and 27.

FIG. 26 is a diagram illustrating an example of the invoice list screen of the first embodiment. A screen 265 illustrated in FIG. 26 is an example of the invoice list screen displayed on the buyer terminal 300 at step S2504 in FIG. 25.

The screen 265 includes a display field 266, which includes operation buttons 267 and 268.

The display field 266 displays a list of received invoice information items stored in the received invoice DB 264A for Corporation A as the buyer. In the example of FIG. 26, the received invoice information item including B Corporation as the biller and an invoice number “30126” includes a plurality of order sheet numbers, indicating that the invoice identified with the invoice number “30126” is a combined invoice for a plurality of order sheets.

Further, in the example of FIG. 26, the reconciliation result of the received invoice information item with the invoice number “30126” is “matched (combined),” indicating that the sum of the total amounts included in the order sheets identified with the plurality of order sheet numbers matches the total amount included in the invoice.

That is, in the first embodiment, the buyer terminal 300 displays association information in which a plurality of order sheet information items registered by the buyer terminal 300 are associated with an invoice information item corresponding to the plurality of order sheet information items and registered by the supplier terminal 400. The association information further includes information representing the result of reconciliation between the plurality of order sheet information items and the invoice information item.

Further, in the example of FIG. 26, the status of the received invoice information item with the invoice number “30126” is “unconfirmed,” indicating that the reconciliation result of the received invoice information item has not been checked by the buyer.

The operation button 267 is used to view the received invoice information item, the reconciliation result of which has been checked by the buyer, i.e., the status of which is “confirmed.”

The operation button 268 is used to transition the screen 265 to a check screen for checking the invoice identified with the invoice number “30126.”

When the operation button 268 is selected, the buyer terminal 300 transmits a check screen display request to the transaction management apparatus 200.

FIG. 27 is a diagram illustrating an example of the check screen of the first embodiment. A screen 275 illustrated in FIG. 27 is an example of the check screen displayed on the buyer terminal 300 at step S2508 in FIG. 25. The screen 275 illustrated in FIG. 27 is an example of the check screen displayed when the result of the reconciliation process by the reconciliation unit 284 is “matched.”

The screen 275 displays the order sheet information items for the combined invoicing and the invoice information of the combined invoice. The screen 275 is also used to input the journal information corresponding to the invoice information and the payment method for paying the invoice amount.

Specifically, the screen 275 includes display fields 276, 277, 278, and 279, input fields 291 and 292, and an operation button 293.

The display field 276 displays the order sheet information item with the order sheet number “190187” for the combined invoicing. The display field 277 displays the order sheet information item with the order sheet number “190188” for the combined invoicing.

The display field 276 includes an operation button 276a, and the display field 277 includes an operation button 277a. When the operation button 276a is selected on the buyer terminal 300, the transaction management apparatus 200 causes the buyer terminal 300 to display the order sheet image corresponding to the order sheet number “190187.” When the operation button 277a is selected on the buyer terminal 300, the transaction management apparatus 200 causes the buyer terminal 300 to display the order sheet image corresponding to the order sheet number “190188.”

The display field 278 displays the amount of the sum of the total amounts included in the order sheet information items for the combined invoicing.

The display field 279 displays the invoice information of the combined invoice with the invoice number “30126,” i.e., the invoice information created based on the order sheet information items displayed in the display fields 276 and 277. The example of FIG. 27 indicates that the total amount displayed in the display filed 279 matches the amount of the sum displayed in the display filed 278.

The display field 279 further includes an operation button 279a. When the operation button 279a is selected on the buyer terminal 300, the transaction management apparatus 200 causes the buyer terminal 300 to display the invoice image corresponding to the invoice number “30126.”

The input field 291 is used to input the journal information. The input field 291 may include input fields of various items related to the journal. The input field 292 is used to specify the payment method. The input field 292 may also display the payee account specified by the biller, for example. The payee account displayed in the input field 292 may be edited.

The input fields 291 and 292 are therefore used to input information related to the invoice information.

The operation button 293 is used to confirm the reconciliation result obtained by the reconciliation unit 284. When the operation button 293 is selected on the screen 275, the transaction management apparatus 2(x) changes the status of the invoice information in the received invoice DB 264A to “confirmed” from “unconfirmed.”

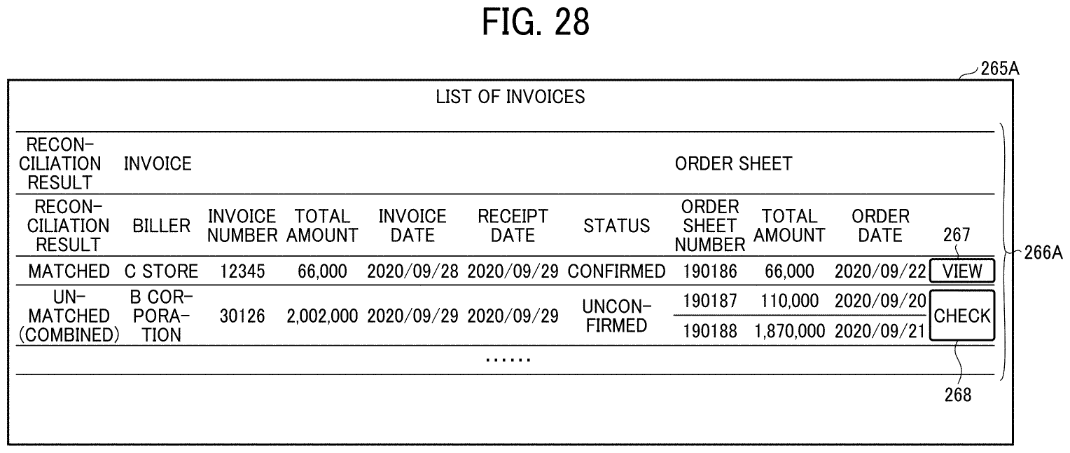

FIG. 28 is a diagram illustrating another example of the invoice list screen of the first embodiment. A screen 265A illustrated in FIG. 28 is an example of the screen displayed when the reconciliation result of the received invoice information item identified with the invoice number “30126” is “unmatched.”

The reconciliation result is “unmatched” w % ben the unit price of an article included in the description information is changed, for example. Specifically, for example, the unit price of a reception table may be increased by 2,000 yen, and the supplier may change the unit price of the reception table to 22,000 yen from 20,000 yen on the invoice creation screen. In this case, the total amount in the invoice does not match the amount of the sum of the total amounts in the order sheets, causing the unmatched reconciliation result.

When the reconciliation result is “unmatched.” the invoice and the order sheets may match in the total amount but may not match in the description information. For example, if the unit price of one article in the description information is increased and the unit price of another article in the description information is reduced, the total amount in the invoice may match the amount of the sum of the total amounts in the order sheets. In this case, however, the invoice and the order sheets do not match in the description information, causing the unmatched reconciliation result.

On the screen 265A, a display field 266A displays a reconciliation result “unmatched (combined).” When the operation button 268 is operated on the screen 265A, the screen 265A transitions to the check screen for checking the invoice identified with the invoice number “30126.”

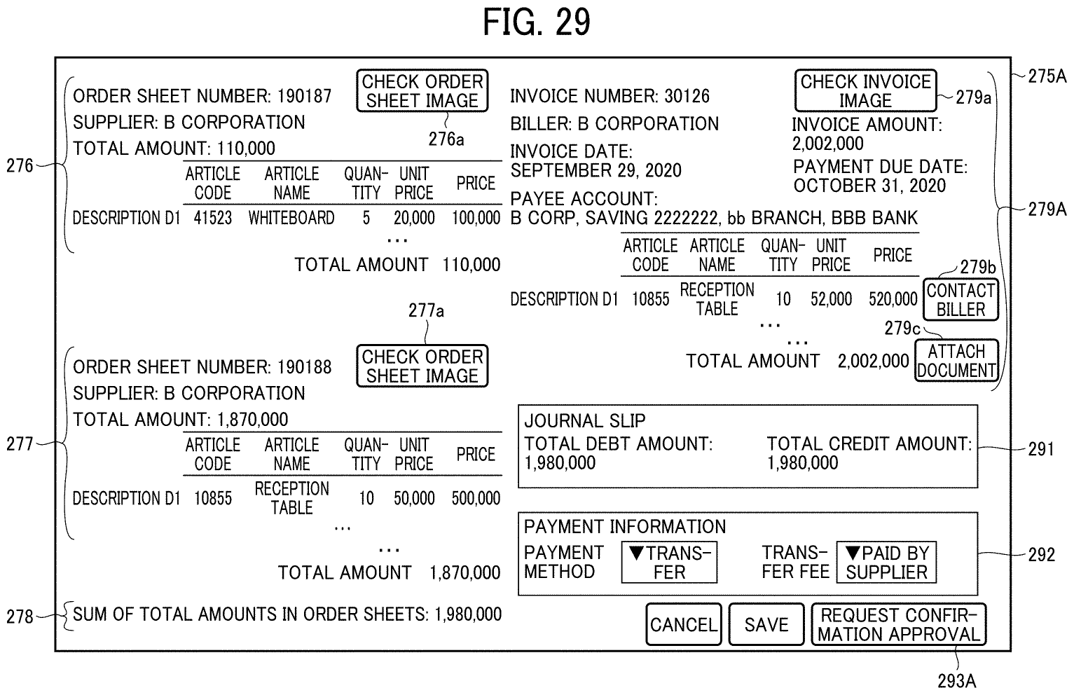

FIG. 29 is a diagram illustrating another example the check screen of the first embodiment. A screen 275A illustrated in FIG. 29 is another example of the check screen displayed on the buyer terminal 300 at step S2508 in FIG. 25. The screen 275A illustrated in FIG. 29 is an example of the check screen displayed when the result of the reconciliation process by the reconciliation unit 284 is “unmatched.”

The screen 275A includes the display fields 276, 277, and 278, a display field 279A, the input fields 291 and 292, and an operation button 293A.

In the example of FIG. 29, the unit price corresponding to an article name “reception table” in one of the issued order sheets is different from the unit price corresponding to the article name “reception table” in the issued combined invoice.

In the example of FIG. 29, therefore, the amount of the sum displayed in the display field 278 does not match the invoice amount displayed in the display field 279A.

The display field 279A includes the operation button 279a and operation buttons 279b and 279c. When the operation button 279b is selected on the buyer terminal 300, the transaction management apparatus 200 transmits a notification to the supplier terminal 400, which has created the invoice information displayed in the display field 279A, to notify that the reconciliation result of the invoice information is unmatched.

Further, when the operation button 279c is selected on the buyer terminal 300, the transaction management apparatus 200 attaches a document to the notification notifying that the reconciliation result is unmatched. The attached document includes a written reply to an inquiry or a series of electronic mails previously exchanged with the supplier, for example.

When the operation button 293A is selected on the buyer terminal 300, the transaction management apparatus 200 transmits a request for approval of confirmation to a terminal associated with a person of the buyer in charge of the transaction, for example.

An electronic mail containing the link to a screen including the information of the screen 275A is transmitted to the person in charge of the transaction, i.e., the person requested to approve the confirmation. Then, if the person clicks an “APPROVE” button displayed on the screen, the confirmation is made. Alternatively, the user operating the buyer terminal 300 may make the confirmation without transmitting the request for approval of confirmation.

As described above, in the first embodiment, a plurality of order sheet information items and an invoice information item for combined invoicing a plurality of order sheets corresponding to the plurality of order sheet information items are managed in association with each other. According to the first embodiment, therefore, when a tenant acting as the buyer or supplier visually checks the result of the reconciliation by the reconciliation unit 284, for example, the plurality of order sheets associated with an invoice corresponding to the invoice information item are readily identified. Consequently, the first embodiment improves the convenience in the reconciliation work.

A second embodiment of the present invention will be described below with reference to drawings.

The second embodiment is different from the first embodiment in that, when a plurality of invoices are issued for delivery in installments of goods ordered with a single order sheet, the plurality of invoices are managed in association with the single order sheet. The following description of the second embodiment will therefore focus on the difference from the first embodiment. Functional units of the second embodiment similar to those of the first embodiment will be denoted with the corresponding reference numerals used in the above description of the first embodiment, and description thereof will be omitted.

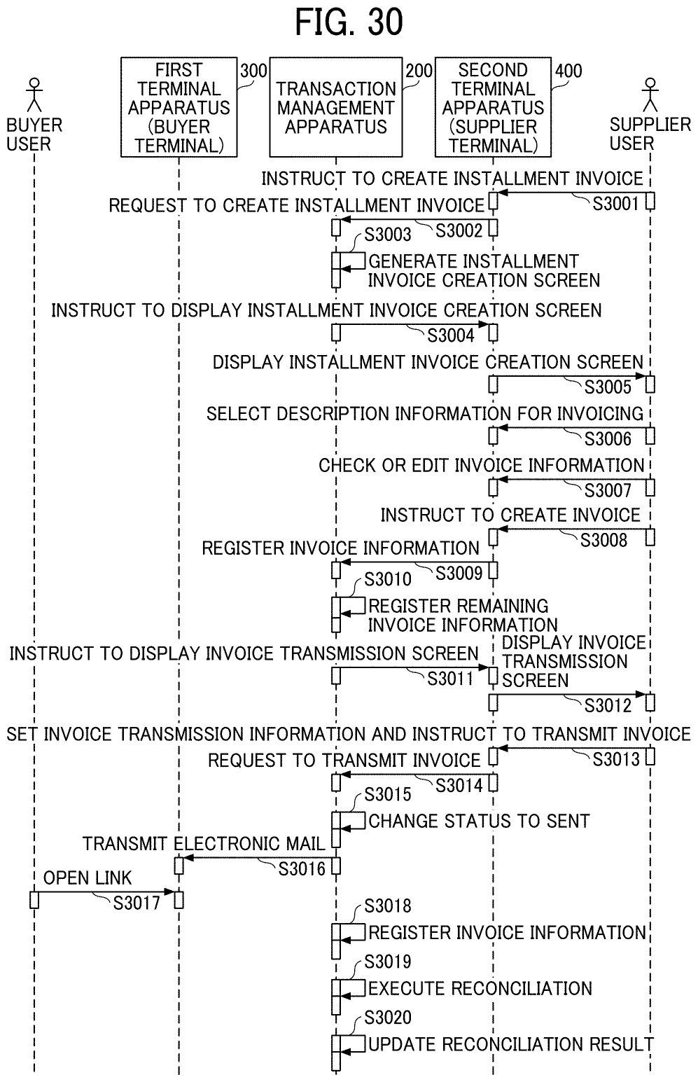

FIG. 30 is a sequence diagram illustrating an operation of the transaction management system 100 of the second embodiment. FIG. 30 illustrates an operation of associating an order sheet with invoices issued for delivery in installments of goods ordered with the order sheet. In the following description, the invoices issued for the delivery in installments of the ordered goods will be described as the installment invoices. Each of the installment invoices corresponds to part of the goods included in the order sheet and delivered in one of the installments.

Further, in the following description, the information representing an installment invoice may be described as the installment invoice information. In the second embodiment, therefore, an order sheet information item is associated with a plurality of installment invoice information items. That is, each of the installment invoice information items includes part of the order sheet information item.

In the transaction management system 100, the supplier terminal 400 displays a screen displaying a list of received order sheet information items, and receives a user instruction to create an installment invoice for a certain order sheet (step S3001). The supplier terminal 400 then transmits an installment invoice creation request to the transaction management apparatus 200 (step S3002).

In response to receipt of the creation request, the display control unit 286 of the transaction management apparatus 200 generates screen data for displaying an invoice creation screen for creating the installment invoice (step S3003). In this process, the display control unit 286 generates the invoice information by referring to the order sheet information item selected for installment invoicing by the supplier terminal 400, and generates the screen data of the invoice creation screen for creating the installment invoice, which includes the generated invoice information.

The transaction management apparatus 200 then transmits a display instruction to the supplier terminal 400 to instruct to display the invoice creation screen for creating the installment invoice (step S3004).

In response to receipt of the display instruction, the display unit 450 of the supplier terminal 400 displays the invoice creation screen (step S3005).

The supplier terminal 400 then receives user selection of the description information for invoicing on the invoice creation screen (step S3006). Then, the supplier terminal 400 receives a user operation of checking or editing the invoice information, for example (step S3007), and receives a user instruction to create the installment invoice on the invoice creation screen (step S3008).

In response to receipt of the invoice creation instruction by the supplier terminal 400, the registration unit 283 of the transaction management apparatus 200 stores the invoice information in the issued invoice DB 263B as the issued invoice information (step S3009). The registration unit 283 then stores the remaining invoice information in the issued invoice DB 263B (step S3010). The remaining invoice information corresponds to part of the description information of the order sheet information not included in the current installment invoice. Details of the processes of steps S3009 and S3010 will be described later.

The processes of steps S3011 and S3020 in FIG. 30 are similar to those of steps S1910 and S1919 in FIG. 19 except that FIG. 30 illustrates an operation for the installment invoice, while FIG. 19 illustrates an operation for the combined invoice. Therefore, description thereof will be omitted here.

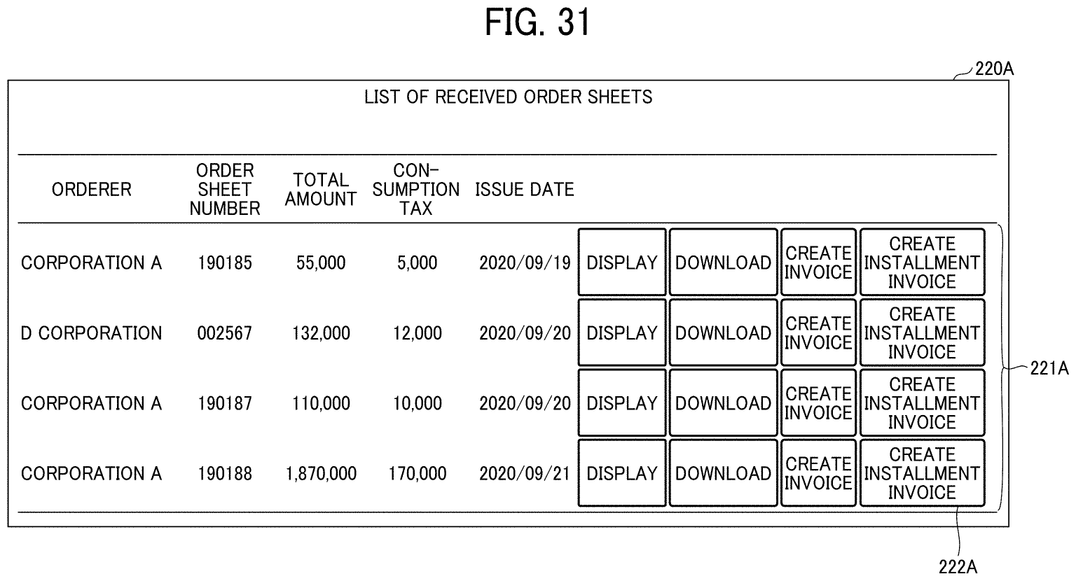

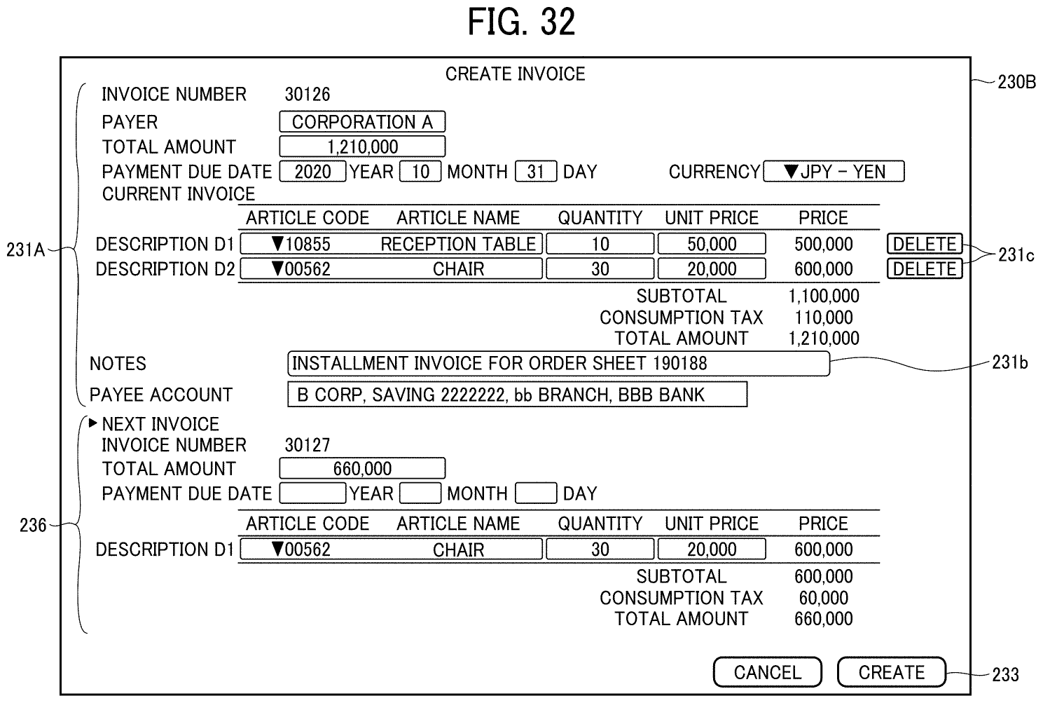

Display examples in the operation illustrated in FIG. 30 will be described with reference to FIGS. 31 and 32.

FIG. 31 is a diagram illustrating an example of the order sheet list screen of the second embodiment. A screen 220A illustrated in FIG. 31 is an example of the screen displayed on the supplier terminal 400 at step S3001 in FIG. 30.

The screen 220A illustrated in FIG. 31 includes a display field 221A. The display field 221A displays a list of order sheet information items, each of which is associated with an operation button for downloading the order sheet information item and an operation button for creating an invoice corresponding to the order sheet information item, for example.

The display field 221A further includes, for each of the order sheet information items, an operation button 222A for creating an installment invoice corresponding to the order sheet information item.

When the operation button 222A is selected, the supplier terminal 400 transmits to the transaction management apparatus 200 a request to create the installment invoice for the order sheet information item corresponding to the selected operation button 222A.

FIG. 32 is a diagram illustrating an example of the invoice creation screen of the second embodiment. A screen 230B illustrated in FIG. 32 is an example of the invoice creation screen displayed on the supplier terminal 400 at step S3005 in FIG. 30. FIG. 32 illustrates an example in which some of the chairs described in the selected order sheet information item are set for the next delivery.

The screen 230B includes a display field 231A, the operation button 233, and a display field 236. The display field 231A displays input fields for inputting the invoice information and the description information to be included in the invoice information of the installment invoice. The display field 231A further includes operation buttons 231c corresponding to respective description information items displayed in the display field 231A.

Each of the operation buttons 231c is used to delete the corresponding description information item from the invoice information of the installment invoice. In the second embodiment, information such as the quantity of an article is editable in the display filed of the description information.

The display field 231A further includes a note field 231b, which may display a message indicating that the current invoice is for installment invoicing for the order sheet with the order sheet number “190188.”

The display field 236 displays the information to be included in the invoice information of the next installment invoice. That is, the display field 236 displays, out of the description information included in the selected order sheet information item, the description information not included in the display field 231A. The display field 236 further displays the corresponding total amount and invoice number, for example. The operation button 233 is used to transmit the instruction to create the installment invoice.

When the operation button 233 is operated on the screen 230B, the supplier terminal 400 transitions the screen 230B to the invoice transmission screen.

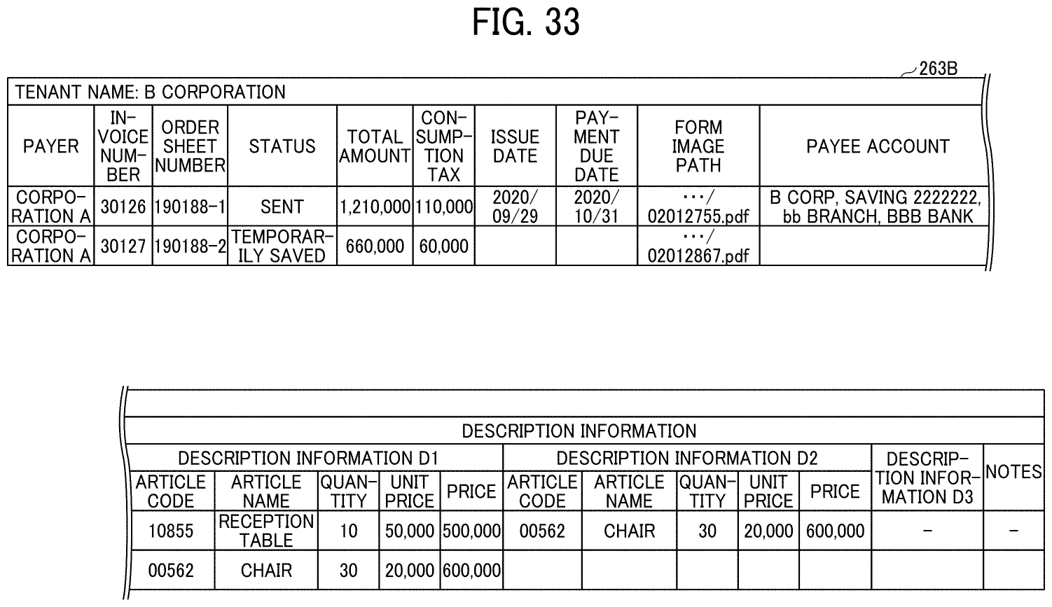

The processes of steps S3009 and S3010 in FIG. 30 will be described with reference to FIG. 33.

FIG. 33 is a diagram illustrating a process of the registration unit 283 of the second embodiment. FIG. 33 illustrates the issued invoice DB 263B in a case in which an installment invoice is issued by B Corporation in response to the order sheet information of an order sheet issued by Corporation A.

When the operation button 233 is operated on the screen 230B in FIG. 32 after the selection of the operation button 222A corresponding to the order sheet number “190188” on the screen 220A in FIG. 31, the invoice information including the description information displayed in the display field 231A in FIG. 32 is generated.

The registration unit 283 associates the invoice information with the payer, the invoice number, the issue date, the payment due date, and the payee account to generate the issued invoice information, and stores the generated issued invoice information in the issued invoice DB 263B. In this process, the registration unit 283 assigns a branch number to the order sheet number included in the issued invoice information.

In the example of FIG. 33, an order sheet number “190188-1” is associated with the invoice number “30126” to indicate that the current invoice is for installment invoicing for the order sheet with the order sheet number “190188.”

The registration unit 283 then creates the invoice information of another installment invoice including other description information included in the order sheet information item identified with the order sheet number “190188.” In this process, the registration unit 283 assigns a new invoice number “30127” to the another installment invoice, sets the order sheet number included in the invoice information of the another installment invoice to “190188-2,” and updates the status of the invoice information to “temporarily saved.”

In this case, the values of information items such as the issue date, the payment due date, and the payee account have not been input in the invoice information including the new invoice number “30127.” Therefore, the fields of these information items are left blank.

When the invoice information of the installment invoice is created, the registration unit 283 of the second embodiment stores, in the issued order sheet DB 261A for the issuer of the order sheet, the order sheet information corresponding to the order sheet number assigned with the branch number.

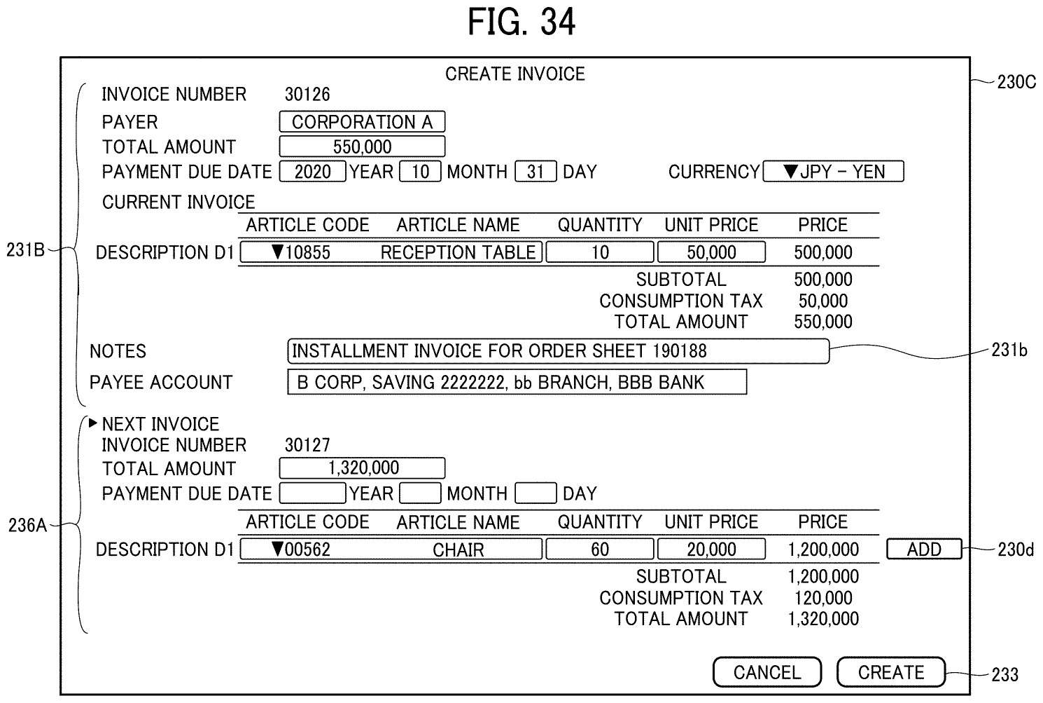

Another example of the invoice creation screen of the second embodiment will be described with reference to FIG. 34.

FIG. 34 is a diagram illustrating another example of the invoice creation screen of the second embodiment. A screen 230C illustrated in FIG. 34 is an example of the invoice creation screen displayed on the supplier terminal 400 at step S3005 in FIG. 30. FIG. 34 illustrates an example in which all of the chairs described in the selected order sheet information item are set for the next delivery.

The screen 230C includes a display field 231B, the operation button 233, and a display field 236A. The display field 231B displays input fields for inputting the invoice information and the description information to be included in the invoice information of the installment invoice. In the example of FIG. 34, the description information item including an article name “chair” is not included in the display field 231B.

The display field 236A displays the total amount in the next installment invoice, the description information item to be added to the next installment invoice, and an operation button 230d corresponding to the description information item.

The operation button 230d is used to add the corresponding description information item to the invoice information of the installment invoice. When the operation button 230d is selected, the description information item corresponding to the operation button 230d is displayed in the display field 231B.

When the installment invoicing is executed for the order sheet information, the registration unit 283 of the second embodiment generates the order sheet information for each installment invoice, and stores the generated order sheet information in the issued order sheet DB 261A for the buyer.

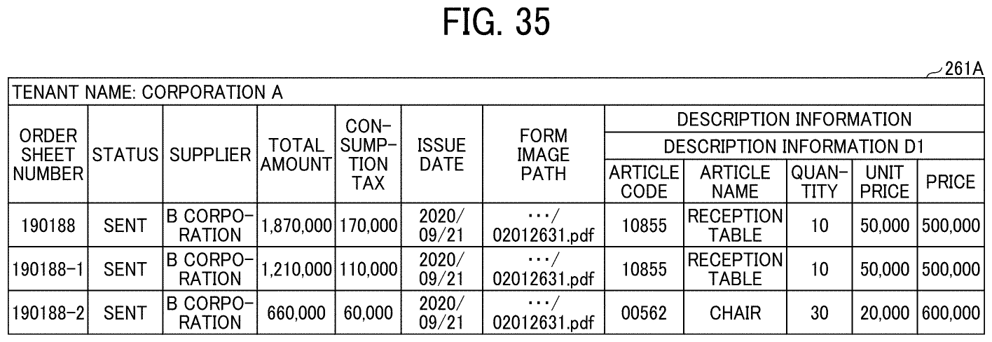

FIG. 35 is a diagram illustrating another process of the registration unit 283 of the second embodiment. When the invoice information of the installment invoice including the order sheet number “190188-1” and the invoice information of the installment invoice including the order sheet number “190188-2” are stored in the issued invoice DB 263B, the registration unit 283 of the second embodiment generates the order sheet information item corresponding to the order sheet number “190188-1” and the order sheet information item corresponding to the order sheet number “190188-2”.

The registration unit 283 then stores the order sheet information item including the order sheet number “190188-1” and the order sheet information item including the order sheet number “190188-2” in the issued order sheet DB 261A, which stores the order sheet information item including the order sheet number “190188.”

In the example of FIG. 35, the order sheet information item including the order sheet number “190188-1” and the order sheet information item including the order sheet number “190188-2” are stored in the issued order sheet DB 261A, and the status of these order sheet information items are “sent” similarly to that of the order sheet information item including the order sheet number “190188.”

The registration unit 283 of the second embodiment further adds (i.e., stores) the order sheet information item including the order sheet number “190188-1” and the order sheet information item including the order sheet number “190188-2” to the received order sheet DB 262B for the supplier.

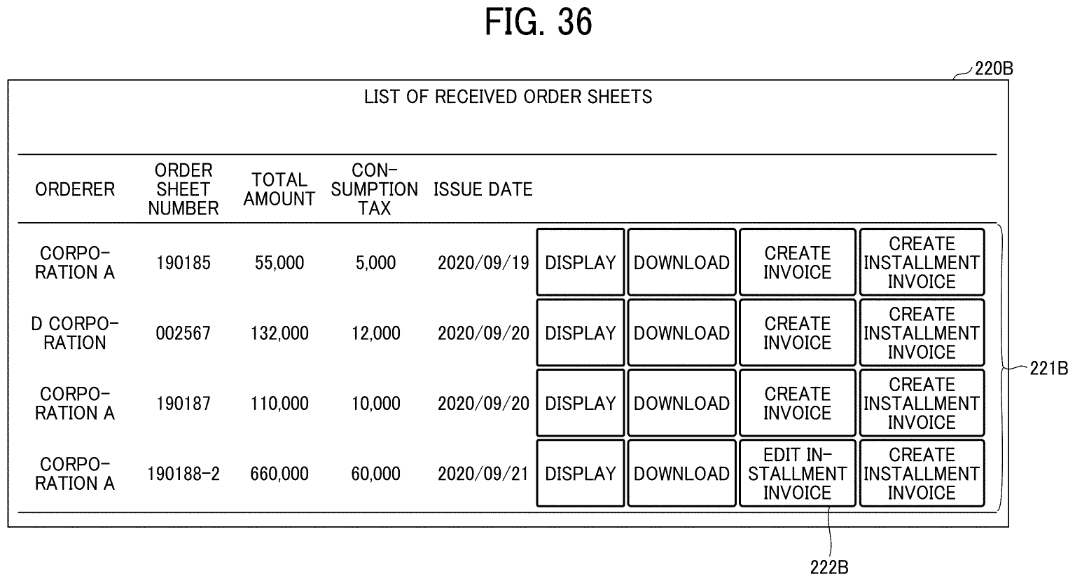

With reference to FIG. 36, a description will be given of an example of the order sheet list screen displayed on the supplier terminal 400 after the order sheet information item including the order sheet number “190188-1” and the order sheet information item including the order sheet number “190188-2” are added to the received order sheet DB 262B.

FIG. 36 is a diagram illustrating another example of the order sheet list screen of the second embodiment. A screen 220B illustrated in FIG. 36 is an example of the screen displayed on the supplier terminal 400. Specifically, the screen 220B is an example of the order sheet list screen displayed on the supplier terminal 400 after a transmission request is transmitted to the transaction management apparatus 200 from the supplier terminal 400 to request to transmit the invoice information of the installment invoice corresponding to the order sheet number “190188-1.”

The screen 220B includes a display field 221B. A list of order sheet information items displayed in the display field 221B includes the order sheet information item including the order sheet number “190188-2.” The display field 221B further displays an operation button 222B for creating the installment invoice corresponding to the order sheet information item including the order sheet number “190188-2.”

When the operation button 222B is selected on the screen 220B, the supplier terminal 400 displays the invoice creation screen for creating the installment invoice corresponding to the order sheet information item with the order sheet number “190188-2.”

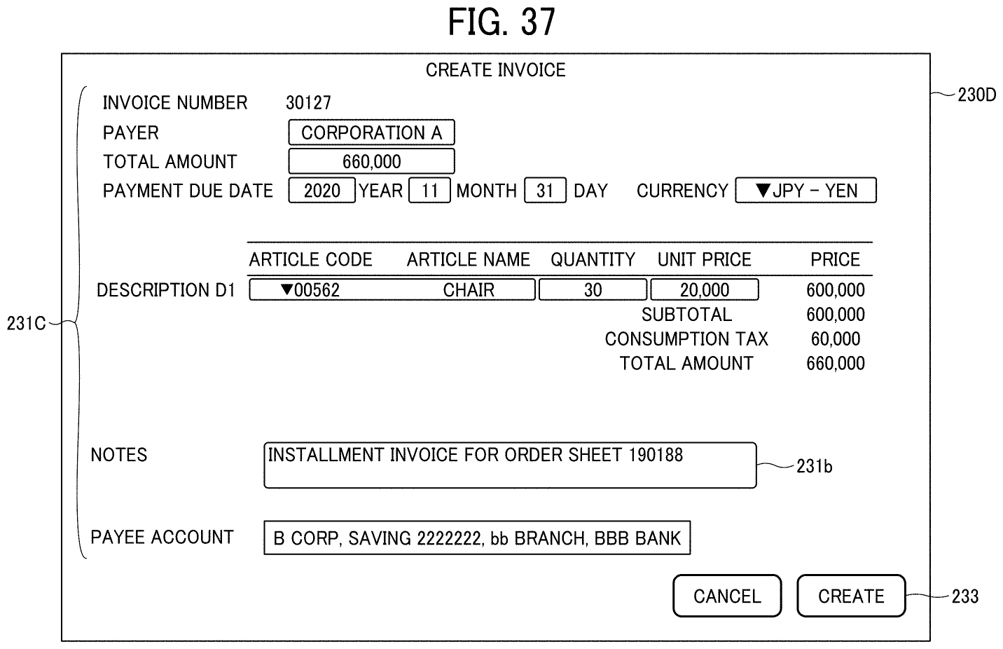

FIG. 37 is a diagram illustrating another example of the invoice creation screen of the second embodiment. A screen 230D illustrated in FIG. 37 includes a display field 231C and the operation button 233.

The display field 231C displays the invoice information based on the content of the next invoice displayed in the display field 236A on the screen 230C in FIG. 34.

When the operation button 233 is selected on the screen 230D, the registration unit 283 of the transaction management apparatus 200 stores information items such as the issue date, the payment due date, and the payee account of the invoice information including the order sheet number “190188-2” into the issued invoice DB 263B based on the invoice information of the installment invoice displayed in the display field 231C.

Further, in response to receipt of a request from the supplier terminal 400 to transmit the invoice information of the installment invoice created on the screen 230D, the transaction management apparatus 200 sets the status of the invoice information item including the order sheet number “190188-2” to “sent” in the issued invoice DB 263B for B Corporation as the supplier.

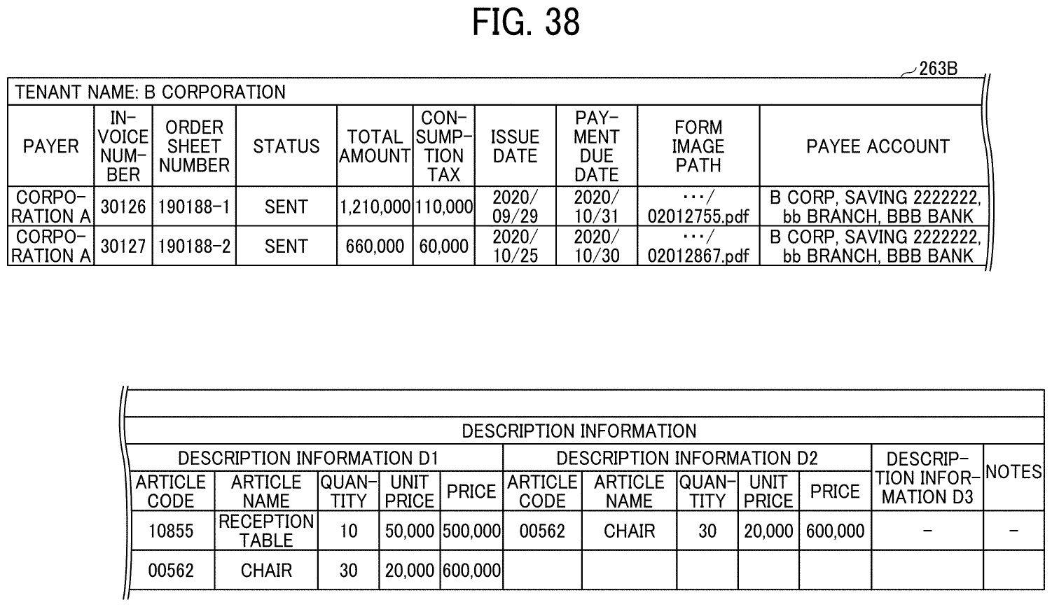

FIG. 38 is a diagram illustrating another process of the registration unit 283 of the second embodiment. It is understood from the issued invoice DB 263B illustrated in FIG. 38 that the information items such as the issue date, the payment due date, and the payee account are stored in the invoice information item assigned with the invoice number “30127” and including the order sheet number “190188-2.”

Further, when an operation of receiving the invoice information of the installment invoice with the invoice number “30127” is performed on the buyer terminal 300, the registration unit 283 of the second embodiment stores the received invoice information of the installment invoice with the invoice number “30127” in the received invoice DB 264A.

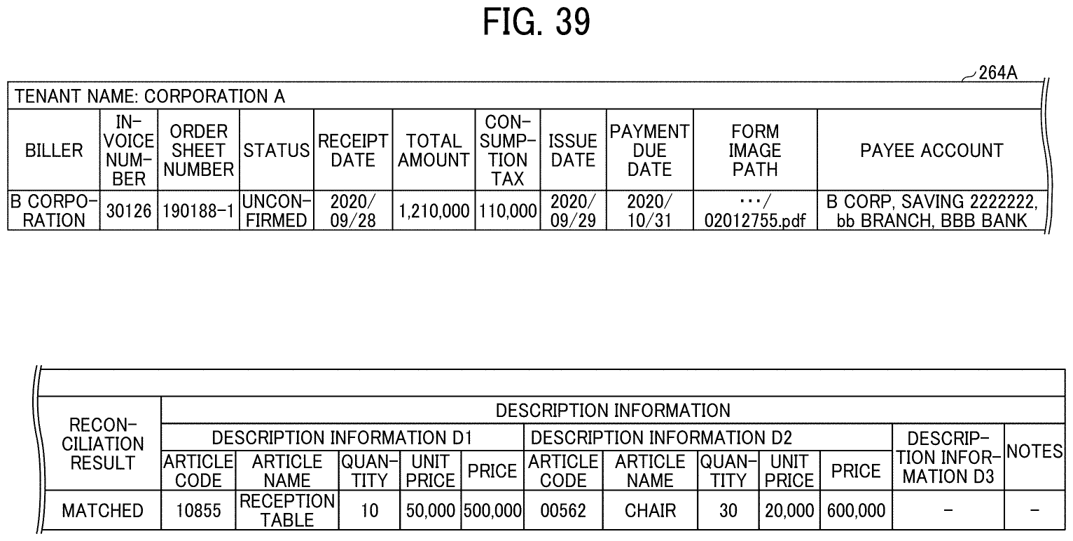

FIG. 39 is a diagram illustrating another process of the registration unit 283 of the second embodiment. In response to receipt from the buyer terminal 300 of a notification that the invoice information with the invoice number “30126” has been received, the registration unit 283 acquires the invoice information with the invoice number “30126” from the issued invoice DB 263B, and stores the acquired invoice information in the received invoice DB 264A for Corporation A as the received invoice information.

Further, in response to receipt of the notification that the invoice information with the invoice number “30126” has been received, the reconciliation unit 284 of the transaction management apparatus 200 executes the reconciliation between the invoice information with the invoice number “30126” and the order sheet information with the order sheet number “190188-2” stored in the issued order sheet DB 261A. The registration unit 283 then includes the reconciliation result in the received invoice information.

The example of FIG. 39 indicates that the status of the received invoice information is “unconfirmed,” and that the reconciliation result of the received invoice information is “matched.”

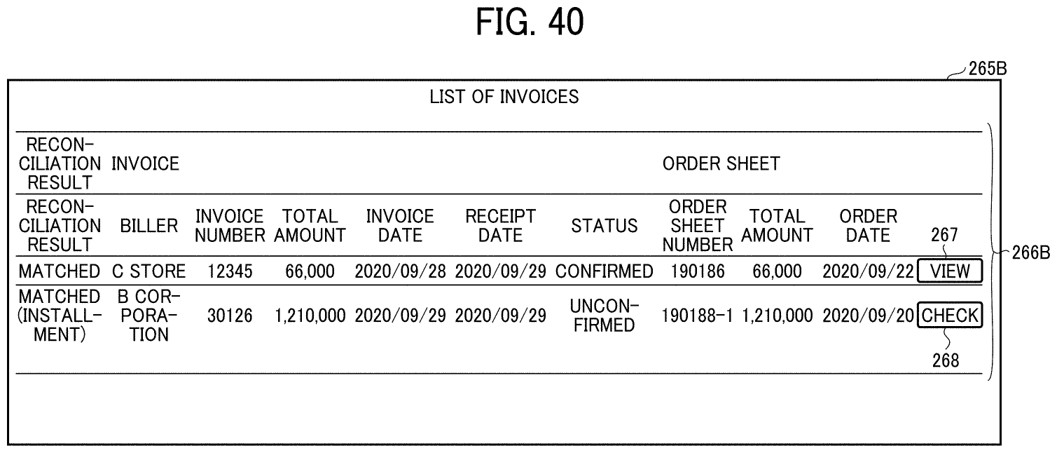

FIG. 40 is a diagram illustrating an example of the invoice list screen of the second embodiment. A screen 265B illustrated in FIG. 40 includes a display field 266B, which includes the operation buttons 267 and 268. The display field 266B displays a list of received invoice information items stored in the received invoice DB 264A for Corporation A as the buyer.

In the example of FIG. 40, the invoice number “30126” and the order sheet number “190188-1” are associated with each other. The example therefore indicates that the invoice information item identified with the invoice number “30126” is the invoice information of the installment invoice corresponding to part of the order sheet information item identified with the order sheet number “190188.”

The example of FIG. 40 further indicates that the result of the reconciliation between the order sheet information item with the order sheet number “190188-1” and the invoice information item with the invoice number “30126” is matched.

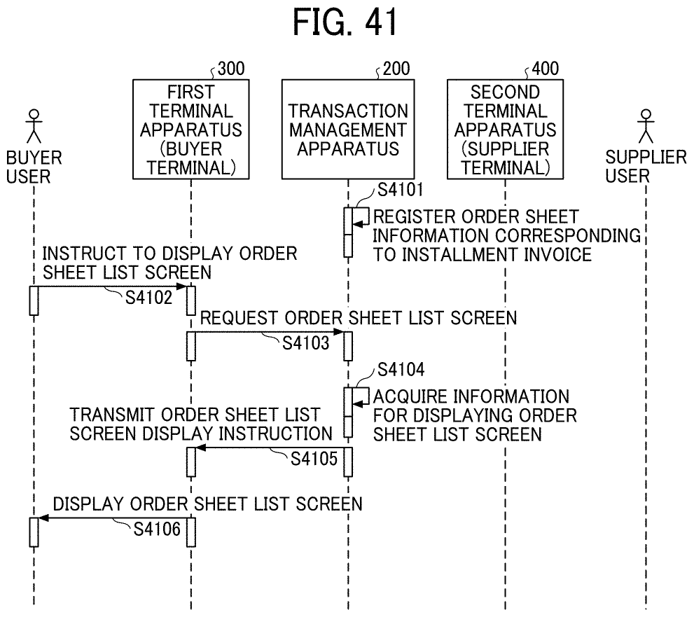

An operation of displaying the order sheet list screen on the supplier terminal 400 will be described with reference to FIG. 41.

FIG. 41 is a sequence diagram illustrating another operation of the transaction management system 100 of the second embodiment. In the transaction management apparatus 200 of the second embodiment, when the invoice information of the installment invoice is stored in the issued invoice DB 263B for the supplier, the registration unit 283 stores the issued order sheet information corresponding to the invoice information of the installment invoice in the issued order sheet DB 261A for the buyer (step S4101). The process of step S4101 corresponds to the process described above with FIG. 35.

Then, the buyer terminal 300 receives a user instruction to display the order sheet list screen (step S4102), and transmits a display request to the transaction management apparatus 200 to request to display the order sheet list screen (step S4103).

In response to receipt of the display request, the information acquisition unit 282 of the transaction management apparatus 200 acquires the information for displaying the order sheet list screen (step S4104).

Specifically, the information acquisition unit 282 extracts information items such as the order sheet number, the total amount, and the order date from the issued order sheet information stored in the issued order sheet DB 261A for the buyer. The information acquisition unit 282 further refers to the received invoice DB 264A and identifies the received invoice information including the order sheet number extracted from the issued order sheet DB 261A.

Then, if the received invoice information including the order sheet number exists for part of the issued order sheet information extracted from the issued order sheet DB 261A, the information acquisition unit 282 associates the received invoice information with information “invoice received” as the invoice receipt status. If the received invoice information including the order sheet number does not exist for part of the issued order sheet information extracted from the issued order sheet DB 261A, the information acquisition unit 282 associates the received invoice information with information “invoice unissued” as the invoice receipt status.

The thus-acquired information is used to display the order sheet list screen.

Then, in the transaction management apparatus 200, the display control unit 286 transmits a display instruction to the buyer terminal 300 to instruct to display the order sheet list screen (step S4105).

In response to receipt of the display instruction from the transaction management apparatus 200, the display unit 340 of the buyer terminal 30) displays the order sheet list screen (step S4106).

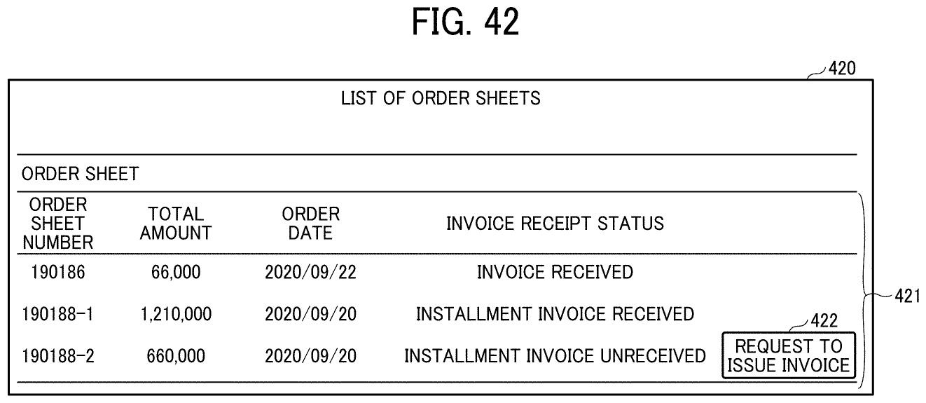

The order sheet list screen displayed on the buyer terminal 300 will be described with reference to FIG. 42.

FIG. 42 is a diagram illustrating another example of the order sheet list screen of the second embodiment. A screen 420 illustrated in FIG. 42 is an example of the order sheet list screen displayed on the buyer terminal 300 at step S4106 in FIG. 41.

The screen 420 includes a display field 421. The display field 421 displays part of each issued order sheet information item acquired from the issued order sheet DB 261A for the buyer and the invoice receipt status associated with the part of the issued order sheet information item based on the received invoice DB 264A.

Specifically, the display field 421 displays the order sheet number, the total amount, and the order date as the part of the issued order sheet information item. In FIG. 42, the display field 421 displays order sheet numbers with branch numbers. The example of FIG. 42 therefore indicates that the installment invoicing has been executed for the order sheet identified with the order sheet number “190188.”

The display field 421 further includes an operation button 422. The operation button 422 is displayed in association with the order sheet number not corresponding to the invoice receipt status “invoice received.”

In the example of FIG. 42, the invoice receipt status corresponding to the order sheet number “190188-2” is “installment invoice unreceived,” and the operation button 422 is displayed in association with the order sheet number “190188-2.”

When the operation button 422 is selected on the buyer terminal 300, the transaction management apparatus 200 transmits a notification to the supplier identified from the issued order sheet information item associated with the selected operation button 422 to request the supplier to issue the invoice, for example.

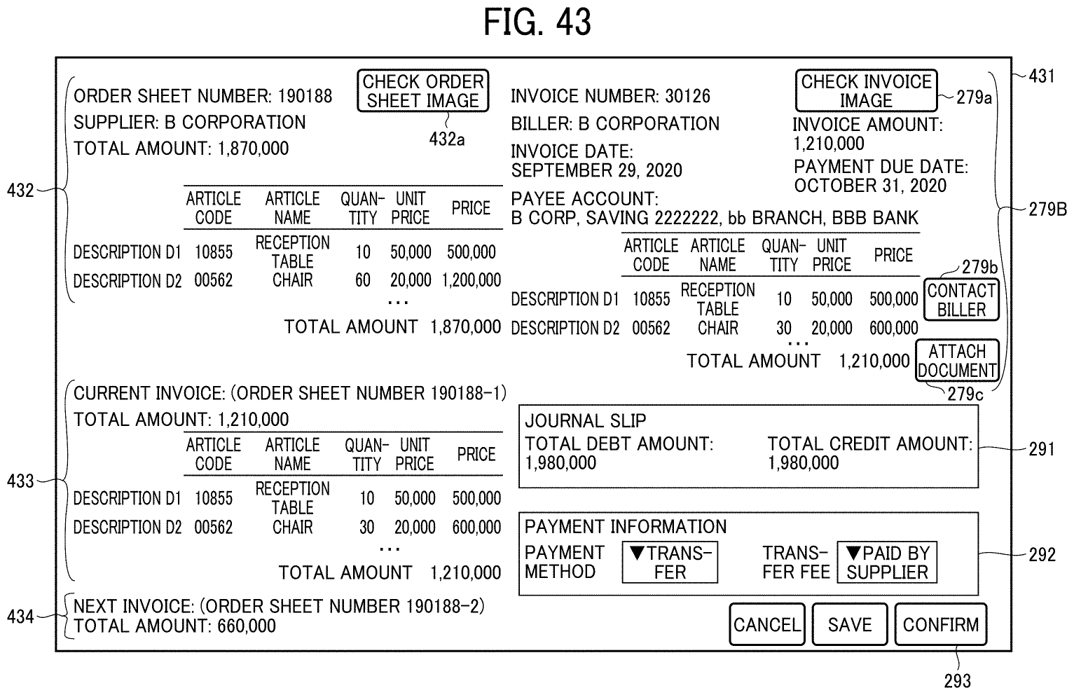

FIG. 43 is a diagram illustrating an example of the check screen of the second embodiment. A screen 431 illustrated in FIG. 43 is an example of the check screen displayed on the buyer terminal 300 when the operation button 268 is selected on the screen 265B in FIG. 40.

The screen 431 includes display fields 432, 433, 434, and 279B, the input fields 291 and 292, and the operation button 293.

The display field 279B displays the invoice information of the installment invoice for the order sheet identified with the order sheet number “190188.” In the example of FIG. 43, the display field 279B displays the invoice information of the installment invoice with the invoice number “30126.”

On the screen 431, the display field 432 displays the order sheet information of the order sheet issued by the buyer terminal 300, and the display field 433 displays the order sheet information corresponding to the invoice information of the installment invoice displayed in the display field 279B. The display field 434 displays the order sheet information corresponding to the next installment invoice.

Specifically, the display field 433 displays the order sheet information assigned with the order sheet number “190188-1” and corresponding to the installment invoice with the invoice number “30126.” Further, the display field 434 displays the order sheet information assigned with the order sheet number “190188-2” and corresponding to the next installment invoice.

In the example of FIG. 43, the total amount displayed in the display field 433 matches the total amount displayed in the display field 279B. Further, the description information displayed in the display field 432 and the description information displayed in the display field 433 match the description information displayed in the display field 279B. Consequently, the reconciliation result is “matched.”

As described above, according to the second embodiment, a single order sheet information item is manageable in association with a plurality of invoice information items each including part of the single order sheet information item.

A third embodiment of the present invention will be described below with reference to drawings.

The third embodiment is a combination of the first embodiment and the second embodiment. According to the third embodiment, therefore, a combined invoice is created which combines the remaining part of the order sheet information item left by the installment invoicing with another order sheet information item.

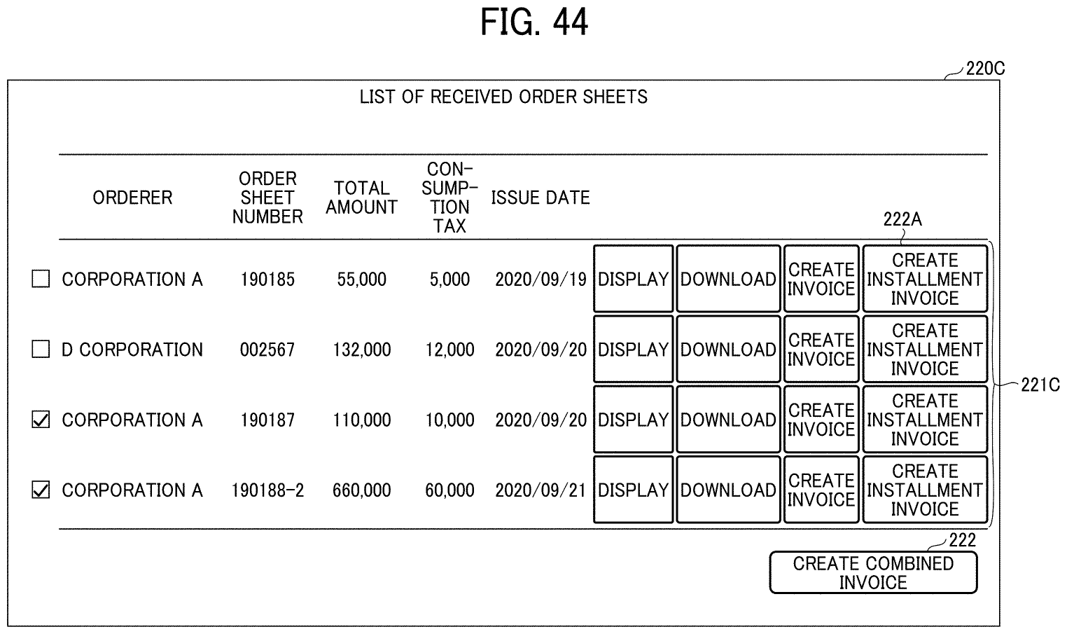

FIG. 44 is a diagram illustrating an example of the order sheet list screen of the third embodiment. A screen 220C illustrated in FIG. 44 is an example of the screen displayed on the supplier terminal 400.

Specifically, the screen 220C includes a display field 221C and the operation button 222. The display field 221C displays a list of order sheet information items, each of which is associated with an operation button for downloading the order sheet information item and an operation button for creating an invoice corresponding to the order sheet information item, for example.

In the display field 221C, each of the order sheet information items in the list is associated with the corresponding operation button 222A for creating an installment invoice corresponding to the order sheet information item.

On the screen 220C, the order sheet with the order sheet number “190187” and the order sheet with the order sheet number “190188-2” are selected from the order sheets issued by Corporation A. The order sheet with the order sheet number “190188-2” includes the remaining part of the order sheet information of the order sheet with the order sheet number “190188” left after the installment invoicing of part of the order sheet information of the order sheet with the order sheet number “190188.”

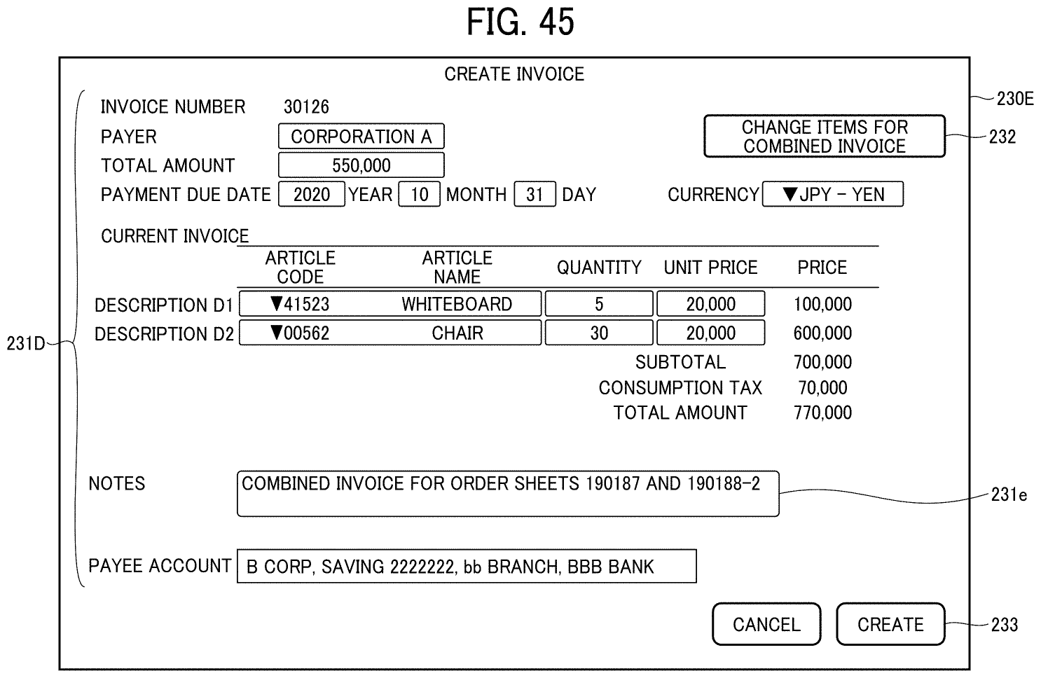

When the operation button 222 is operated on the screen 220C, the supplier terminal 400 transmits a creation instruction to the transaction management apparatus 200 to instruct to create a combined invoice including the order sheet information item identified with the order sheet number “190187” and the order sheet information item identified with the order sheet number “190188-2.” In response to receipt of the creation instruction, the transaction management apparatus 200 causes the supplier terminal 400 to display the invoice creation screen illustrated in FIG. 45.

FIG. 45 is a diagram illustrating an example of the invoice creation screen of the third embodiment. A screen 230E illustrated in FIG. 45 includes a display field 231D and the operation button 233.

The display field 231D displays the invoice information based on the order sheet information item identified with the order sheet number “190187” and the order sheet information item identified with the order sheet number “190188-2.”

The display field 231D further includes the operation button 232 and a note field 231e. The note field 231e displays a message indicating that the current invoice is for combined invoicing for the order sheet identified with the order sheet number “190187” and the order sheet identified with the order sheet number “190188-2.”

When the operation button 233 is selected on the screen 230E, the registration unit 283 of the transaction management apparatus 200 stores information items such as the issue date, the payment due date, and the payee account of the invoice information including the invoice number “30126” into the issued invoice DB 263B based on the invoice information of the combined invoice displayed in the display field 231D.

Further, in the third embodiment, when an operation of receiving the invoice information including the invoice number “30126” is performed on the buyer terminal 300, the transaction management apparatus 200 stores the invoice information including the invoice number “30126” in the received invoice DB 264A.

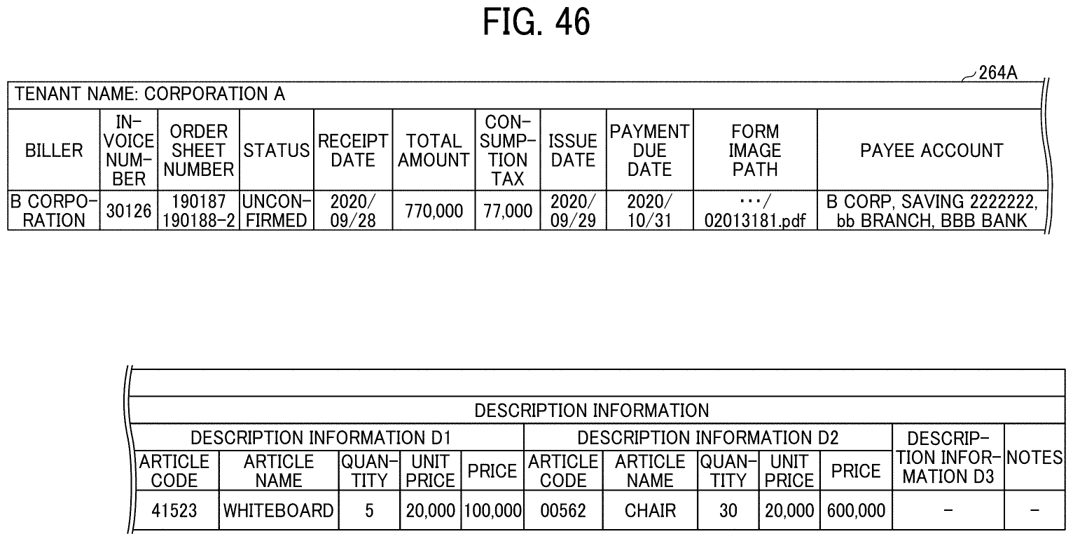

FIG. 46 is a diagram illustrating an example of the received invoice DB 264 of the third embodiment. In the received invoice DB 264A illustrated in FIG. 46, the invoice number “30126” and the order sheet numbers “190187” and “190188-2” are associated with each other, indicating that the invoice information is that of a combined invoice.

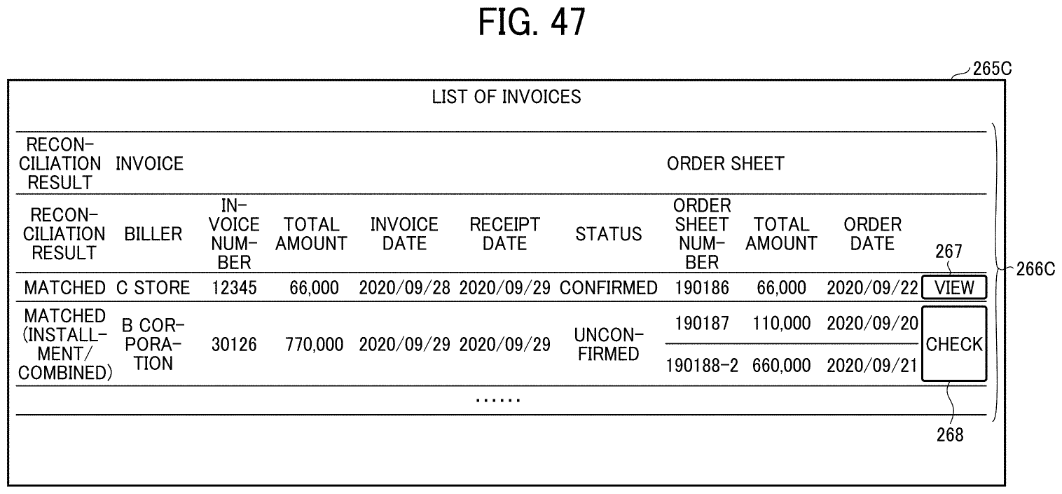

FIG. 47 is a diagram illustrating an example of the invoice list screen of the third embodiment. A screen 265C illustrated in FIG. 47 includes a display field 266C, which includes the operation buttons 267 and 268. The display field 266C displays a list of received invoice information items stored in the received invoice DB 264A for Corporation A as the buyer.

In the example of FIG. 47, the invoice number “30126” is associated with the order sheet numbers “190187” and “190188-2.” It is therefore understood that the received invoice information item with the invoice number “30126” is the invoice information of the combined invoice corresponding to the order sheet information item identified with the order sheet number “190187” and the order sheet information item identified with the order sheet number “190188-2.”

The example of FIG. 47 further indicates that the result of reconciling the invoice information item including the invoice number “30126” with the order sheet information item identified with the order sheet number “190187” and the order sheet information item identified with the order sheet number “190188-2” is matched.

As described above, the third embodiment enables the creation of a combined invoice corresponding to a remaining part of an order sheet information item subjected to installment invoicing and another order sheet information item not subjected to installment invoicing.

In the foregoing embodiments, the first form and the second form to be associated with each other are the order sheet and the invoice, respectively. The first form and the second form, however, are not limited to the order sheet and the invoice, respectively. The foregoing embodiments are applicable to any forms involving the reconciliation work of determining whether the forms match in content. Specifically, for example, the first form and the second form to be associated with each other may be the order sheet and the statement of delivery, respectively. Further, the first form and the second form may be the quotation and the order sheet, respectively.

The apparatuses described in each of the embodiments form one of a plurality of computing environments for implementing the embodiment disclosed in the present specification.

In an embodiment of the present invention, the transaction management apparatus 200 is a server cluster including a plurality of computing devices configured to communicate with each other via a desired type of communication link such as a network or a shared memory, for example, to execute the processes disclosed in the present specification. Similarly, the transaction management apparatus 200 may include a plurality of computing devices configured to communicate with each other.

Further, the transaction management apparatus 200 may be configured to share the disclosed process steps with another apparatus in various combinations. For example, a process executed by the transaction management apparatus 200 as a server may be executed by another server. Similarly, a function of the transaction management apparatus 200 may be executed by another server. Further, the components of the transaction management apparatus 200 as a server and the components of another server may be integrated in a single server, or may be distributed to a plurality of apparatuses.

The correspondence tables described in the present specification may be generated as a result of machine learning. Further, if keywords and account items that may be included in a transaction description are categorized by machine learning, it is unnecessary to use the correspondence tables.

Herein, machine learning refers to a technology for causing a computer to acquire learning ability comparable to that of humans. According to the technology, the computer autonomously generates, from previously learned data, algorithms for making decisions such as data identification, and makes predictions by applying the algorithms to new data. The learning method for machine learning may be any of supervised learning, unsupervised learning, semi-supervised learning, reinforcement learning, and deep learning, or may be a combination of two or more of these learning methods. The learning method for machine learning is not limited to a particular method.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions. Further, the above-described steps are not limited to the order disclosed herein.

1. An information processing apparatus comprising circuitry configured to
register a plurality of first form information items based on an operation of a first terminal apparatus,
generate a second form information item corresponding to the plurality of first form information items based on an operation of a second terminal apparatus, and register the generated second form information item in association with the plurality of first form information items, and
cause the first terminal apparatus to display association information in which the plurality of first form information items and the second form information item are associated with each other.

2. The information processing apparatus of claim 1, wherein the association information includes information representing a result of reconciliation between the plurality of first form information items and the second form information item.

3. The information processing apparatus of claim 1, wherein the circuitry causes the first terminal apparatus to display a screen including
a display field for displaying the plurality of first form information items,
a display field for displaying the second form information item, and
an input field for inputting information related to the second form information item.

4. The information processing apparatus of claim 1, wherein the circuitry reconciles the plurality of first form information items with the second form information item.

5. The information processing apparatus of claim 1, wherein the circuitry
registers a first form information item based on the operation of the first terminal apparatus, and
generates a plurality of second form information items corresponding to the first form information item based on the operation of the second terminal apparatus, and registers the generated plurality of second form information items in association with the first form information item,
wherein the first form information item and the plurality of second form information items are associated with each other in the association information, and
wherein each of the plurality of second form information items includes part of the first form information item, the part of the first form information item being extracted from the first form information item based on the operation of the second terminal apparatus.

6. The information processing apparatus of claim 1, wherein the plurality of first form information items are order sheet information, and the second form information item is invoice information.

7. An information processing system comprising:
the information processing apparatus of claim 1;
a first terminal apparatus including
first circuitry configured to receive input of the plurality of first form information items, and
a display configured to display the association information; and
a second terminal apparatus including
second circuitry configured to receive input of the second form information item.

8. An information processing system comprising;
an information processing apparatus; and
a first terminal apparatus,
the information processing apparatus including circuitry configured to
register a plurality of first form information items based on an operation of the first terminal apparatus,
generate a second form information item corresponding to the plurality of first form information items based on an operation of a second terminal apparatus, and register the generated second form information item in association with the plurality of first form information items, and
transmit, to the first terminal apparatus, association information in which the plurality of first form information items and the second form information item are associated with each other, and
the first terminal apparatus including
a display configured to display the association information.

9. The information processing system of claim 8, wherein the first terminal apparatus further includes first circuitry configured to receive input of the plurality of first form information items, and
wherein the information processing system further comprises the second terminal apparatus including second circuitry configured to receive input of the second form information item.

10. An information processing method comprising:
registering a plurality of first form information items based on an operation of a first terminal apparatus;
generating a second form information item corresponding to the plurality of first form information items based on an operation of a second terminal apparatus, and registering the generated second form information item in association with the plurality of first form information items; and
causing the first terminal apparatus to display association information in which the plurality of first form information items and the second form information item are associated with each other.

11. The information processing method of claim 10, wherein the association information includes information representing a result of reconciliation between the plurality of first form information items and the second form information item.

12. The information processing method of claim 10, wherein the causing includes causing the first terminal apparatus to display a screen including
a display field for displaying the plurality of first form information items,
a display field for displaying the second form information item, and
an input field for inputting information related to the second form information item.

13. The information processing method of claim 10, further comprising reconciling the plurality of first form information items with the second form information item.

14. The information processing method of claim 10, further comprising:
registering a first form information item based on the operation of the first terminal apparatus; and
generating a plurality of second form information items corresponding to the first form information item based on the operation of the second terminal apparatus, and registering the generated plurality of second form information items in association with the first form information item,
wherein the first form information item and the plurality of second form information items are associated with each other in the association information, and
wherein each of the plurality of second form information items includes part of the first form information item, the part of the first form information item being extracted from the first form information item based on the operation of the second terminal apparatus.

15. The information processing method of claim 10, wherein the plurality of first form information items are order sheet information, and the second form information item is invoice information.
